(19) United States
(12) Patent Application Publication
(10) Pub. No.: US 2024/0359440 A1
(43) Pub. Date: Oct. 31, 2024

(54) HEAT STABLE BARRIER FILM STRUCTURE

(71) Applicant: AMCOR FLEXIBLES NORTH AMERICA, INC., Neenah, WI (US)

(72) Inventors: Philipp OKLE, Konstanz (DE); Wolfgang LOHWASSER, Gailingen (DE); Peter ETTRIDGE, Worcester (GB); Roy CHRISTOPHERSON, Shrivenham (GB)

(21) Appl. No.: 18/687,751

(22) PCT Filed: Feb. 11, 2022
(86) PCT No.: PCT/US2022/016093

§ 371 Date: Feb. 28, 2024

Related U.S. Application Data
(63) Continuation-in-part of application No. PCT/US2021/049614, filed on Sep. 9, 2021.

(51) Int. Cl. B32B 27/08; B32B 7/02; B32B 27/32; B65D 1/34; B65D 65/40; B65D 75/00

(52) U.S. Cl. CPC B32B 27/08; B32B 7/02; B32B 27/32; B65D 1/34; B65D 65/403; B65D 75/008; B32B 2255/10; B32B 2255/20; B32B 2255/205; B32B 2255/26; B32B 2255/28; B32B 2307/31; B32B 2307/4023; B32B 2307/518; B32B 2307/54; B32B 2307/7244; B32B 2307/7246; B32B 2307/7376; B32B 2439/02; B32B 2439/46; B32B 2553/00; B65D 2565/387

(57) ABSTRACT

This disclosure concerns a barrier packaging film including a polyolefin substrate layer having a thickness in the range of from 10 μm to 100 μm, an inorganic coating layer, and a polymeric buffer layer positioned between the polyolefin substrate and the inorganic coating layer, the polymeric buffer layer in direct contact with the inorganic coating layer, wherein the inorganic coating layer comprises a wave structure characterized by an average amplitude in the range of from 0.25 μm to 1.0 μm and a wavelength in the range of from 2 μm to 5 μm. Also disclosed are packages (e.g., hermetically sealed packages) formed from the barrier packaging film.

### TECHNICAL FIELD

The present invention is related to heat stable multilayer barrier film structures. Embodiments of the present invention are directed to flexible multilayer films for packaging applications.

### BACKGROUND

A typical packaging application involving the exposure of a multilayer barrier structure to thermal stress is retort packaging. In retort packaging, the packaged product undergoes an extended heat and pressure treatment process. Similarly, packaging or packaged product may undergo a pasteurization process at about 80° C. In still another application multilayer barrier structures may be used as a thermal shrink wrap foil at temperatures of 80° C. or lower.

Examples of multilayer heat shrinkable films for use as wrapping foils are disclosed in US patent documents US2006222793 and U.S. Pat. No. 6,627,274.

Food products are increasingly being packaged in flexible retort packages as an alternative to metal cans and glass jars. The packaging material for flexible retort packages typically includes an embedded barrier layer, an outer polymer layer adhered to one side of the barrier layer and forming the exterior surface of the package, and a heat-sealable inner polymer film layer adhered to the other side of the gas barrier layer and forming the interior surface of the package. It is believed that this combination of layers can withstand a retort process without melting or substantially degrading (i.e., leaking, delaminating). In general, retorting consists of heating the packaging container to a temperature in a range of from 100 to 135° C., at an overpressure in a range of from 0.5 to 1.1 bar, for a time period in a range of from 15 to 100 minutes.

Examples of laminates for retort packaging are disclosed in U.S. Pat. Nos. 4,310,578 A; 4,311,742 A; 4,308,084 A; 4,309,466 A; 4,402,172 A; 4,903,841 A; 5,273,797 A; 5,731,090 A; EP 1 466 725 A1; JPH 09 267 868 A; JP 2002 096 864 A; JP 2015 066 721 A; JP 2018 053 180 A; JP 2017 144 648 A; JPS 62 279 944 A; JPS 6 328 642 and JPH 10 244 641 A.

Conventional flexible retort pouches are manufactured with layers of different materials to achieve oxygen, water, bacteria and flavor barrier properties. One typical option for designing resilient retort packaging multilayer barrier films is the use of an aluminum barrier layer having a thickness of at least 5 μm, preferably more than 12 μm thickness. Nevertheless, aluminum is expensive, of high density, subject to pinholes at lower thicknesses after flexing, and has the drawback of opacity. Aluminum is also known to cause problems for reheating a packaged food product in a microwave oven. Moreover, the presence of a metal layer is, in general, undesirable in terms of recycling possibilities and metal detection within the packaging process.

A typical example of a multilayer barrier film structure for standard retort pouches comprises a polyethylene terephthalate exterior layer, a barrier layer, and an inner sealing layer, wherein the exterior layer comprises a printing layer, the barrier layer comprises one or more of a metal foil, a metallized film, or a transparent barrier polymer film and the inner layer is a heat sealable polyolefin layer. The packaging material may also contain an additional polymer film layer such as a polyamide layer or the like.

Besides the recycling issue, due to the presence of the integrated aluminum foil, the diversity of the polymer layers composing the multilayer barrier film structure results in an additional challenge for rendering these multilayer barrier film structures recyclable.

Without contesting the associated advantages of the state-of-the-art systems, there exists a need for a recyclable heat stable multilayer barrier film structure for packaging, wherein the barrier layer remains substantially crack-free during heat treatment, thereby limiting the loss of oxygen and water vapor barrier properties of the film.

### SUMMARY

Embodiments of the present invention advantageously provide a heat resilient barrier film structure for packaging. In some embodiments, the heat resilient barrier film structure is heat treated, for example, during a pasteurization or a retort treatment. In some embodiments, the heat resilient barrier film structure comprises an inorganic barrier layer remaining substantially crack-free during and after the heat treatment, thereby limiting the increase of oxygen and water vapor transmission rate of the film.

In one or more embodiments, the barrier film structures contain one or more inorganic coating layers in contact with at least one buffer layer in a multilayer laminate. In some embodiments, the presence of the buffer layer allows the formation of waves in the inorganic coating layer, thereby avoiding the formation of cracks when a substrate layer shrinks under thermal stress. The usual loss of oxygen and water vapor transmission rate in typical barrier film structures may be reduced due to the presence of the buffer layer, and the transmission rates of the flexible multilayer films described herein can remain acceptable even after heat treatment.

Additional embodiments of the present invention advantageously provide a more sustainable transparent multilayer barrier film showing outstanding oxygen transmission rate (low transmission, high barrier), said oxygen transmission rate remaining substantially unchanged after heat treatment, the heat resilient barrier film structure being relatively easier to recycle than typical high barrier packaging structures.

Some embodiments of the barrier packaging film comprise a polyolefin substrate, the polyolefin substrate comprising a free shrink in the range of from 0.5% to 10% in at least one of the machine direction and the transverse direction at 95° C. according to ASTM D2732, an inorganic coating layer having a thickness in the range of from 0.005 micron to 0.1 micron, a polymeric buffer layer positioned between and in direct contact with each of the polyolefin substrate and the inorganic coating layer, the polymeric buffer layer comprising a thickness in the range of from 0.5 microns to 12 microns, and a polyolefin sealing layer. A ratio of the thickness of the polymeric buffer layer to the thickness of the inorganic coating layer is in the range of from 20 to 500, and the polymeric buffer layer comprises a Young's Modulus in the range of 0.1 MPa to 100 MPa, as calculated from measurements collected at 95° C., according to ASTM E2546-15 with Annex X.4.

Some embodiments of the barrier packaging film further comprise an adhesive layer. Additionally, the polyolefin substrate is a first exterior layer, the polyolefin sealing layer is a second exterior layer, and the adhesive layer is located between the polyolefin sealing layer and the inorganic coating layer. These embodiments may further comprise a printed indicia layer located between the polyolefin sealing layer and the inorganic coating layer.

Some embodiments of the barrier packaging film further comprise a printed indicia layer and an adhesive layer. Additionally, the printed indicia layer is a first exterior layer, the polyolefin sealing layer is a second exterior layer, and the adhesive layer is located between the polyolefin sealing layer and the inorganic coating layer.

In some embodiments of the barrier packaging film the polyolefin substrate is an oriented polypropylene film and the polyolefin sealing layer is a polypropylene sealing layer. The oriented polypropylene film may comprise a homopolymer polypropylene.

In some embodiments of the barrier packaging film the polyolefin substrate is an oriented polyethylene film and the polyolefin sealing layer is a polyethylene sealing layer.

Some embodiments of the barrier packaging film further comprise an oriented polyolefin exterior layer and an adhesive layer. Additionally, the polyolefin sealing layer is a sublayer of the polyolefin substrate, and the adhesive layer is located between the oriented polyolefin exterior layer and the inorganic coating layer. The barrier packaging film may also comprise a printed indicia layer located between the oriented polyolefin exterior layer and the inorganic coating layer.

In some embodiments, the barrier packaging film has a total composition including greater than or equal to 80% polyolefin, greater than or equal to 90% polyolefin or greater than or equal to 95% polyolefin, by weight.

In some embodiments of the barrier packaging film, the polyolefin substrate comprises a thickness in the range of from 10 microns to 100 microns.

In some embodiments of the barrier packaging film, the polymeric buffer layer comprises a thickness in the range of from 1 μm to 5 μm.

In some embodiments of the barrier packaging film, the inorganic coating layer comprises a metal layer or an oxide coating layer and the thickness of the inorganic coating layer is in the range of from 0.005 μm to 0.06 μm.

In some embodiments of the barrier packaging film, the ratio of the thickness of the polymeric buffer layer to the thickness of the inorganic coating layer is in the range of from 30 to 120.

In some embodiments of the barrier packaging film, the polymeric substrate comprises a free shrink of in the range of from 1% to 6% at 95° C. according to ASTM D2732.

In some embodiments of the barrier packaging film, the polymeric buffer layer comprises vinyl alcohol copolymer, polypropylene-based polymer, polyurethane-based polymer or polylactic acid.

The barrier packaging film may further comprise a second polymeric buffer layer in direct contact with the inorganic coating layer.

Some embodiments of the barrier packaging film comprise: a polyolefin substrate, an inorganic coating layer, a polymeric buffer layer positioned between the polyolefin substrate and the inorganic coating layer, the polymeric buffer layer in direct contact with the inorganic coating layer, and a polyolefin sealing layer. Additionally, the inorganic coating layer comprises a wave structure characterized by an average amplitude in the range of from 0.25 μm to 1.0 μm and a wavelength in the range of from 2 μm to 5 μm, and the polymeric buffer layer comprises a thickness in the range of from 1.1 to 20 times the average amplitude of said wave structure.

The barrier packaging film including a wave structure may further comprise an adhesive layer. Additionally, the polyolefin substrate is a first exterior layer, the polyolefin sealing layer is a second exterior layer, and the adhesive layer is located between the polyolefin sealing layer and the inorganic coating layer. The film may further comprise a printed indicia layer located between the polyolefin sealing layer and the inorganic coating layer.

The barrier packaging film including a wave structure may further comprise a printed indicia layer and an adhesive layer. Additionally, the printed indicia layer is a first exterior layer, the polyolefin sealing layer is a second exterior layer, and the adhesive layer is located between the polyolefin sealing layer and the inorganic coating layer.

In some barrier packaging films including a wave structure, the polyolefin substrate is an oriented polypropylene film and the polyolefin sealing layer is a polypropylene sealing layer. The oriented polypropylene film may comprise a homopolymer polypropylene.

In some embodiments of barrier packaging films that include a wave structure, the polyolefin substrate is an oriented polyethylene film and the polyolefin sealing layer is a polyethylene sealing layer.

Some embodiments of barrier packaging films that include a wave structure further comprise an oriented polyolefin exterior layer and an adhesive layer. Further, the polyolefin sealing layer is a sublayer of the polyolefin substrate, and the adhesive layer is located between the polyolefin exterior layer and the inorganic coating layer. Additionally, the barrier packaging film further may comprise a printed indicia layer located between the polyolefin exterior layer and the inorganic coating layer.

Some embodiments of barrier packaging films that include a wave structure have a total composition including greater than or equal to 80% polyolefin, greater than or equal to 90% polyolefin or greater than or equal to 95% polyolefin, by weight.

In some embodiments of barrier packaging films that include a wave structure the polyolefin substrate comprises a thickness in the range of from 10 microns to 100 microns.

In some embodiments of barrier packaging films that include a wave structure the polymeric buffer layer comprises a thickness in the range of from 1 to 5 μm.

In some embodiments of barrier packaging films that include a wave structure the inorganic coating layer comprises a metal layer or an oxide coating layer and a thickness of the inorganic coating layer is in the range of from 0.005 μm to 0.06 μm.

In some embodiments of barrier packaging films that include a wave structure a ratio of the thickness of the polymeric buffer layer to the thickness of the inorganic coating layer is in the range of from 30 to 120.

In some embodiments of barrier packaging films that include a wave structure the wave structure of the inorganic layer is characterized by a ratio of the wavelength to the average amplitude, the ratio in the range of from 2 to 20.

In some embodiments of barrier packaging films that include a wave structure the polymeric buffer layer comprises vinyl alcohol copolymer, polypropylene-based polymer, polyurethane-based polymer or polylactic acid.

Some embodiments of barrier packaging films that include a wave structure further comprise a second polymeric buffer layer in direct contact with the inorganic coating layer.

Also discussed herein are hermetically sealed packages comprising a barrier packaging film according to any embodiment.

### BRIEF DESCRIPTION OF THE DRAWINGS

The disclosure may be more completely understood in consideration of the following detailed description of various embodiments of the disclosure in connection with the accompanying drawings, in which:

FIGS. 1A, 1B, 2, 3, 4, 5A, 5B, 6, 7 and 8 are cross-sectional views of different embodiments of a barrier packaging film;

FIGS. 9 and 10 are perspective views of embodiments of hermetically sealed packages comprising a barrier packaging film;

FIG. 11 is a top-view of a magnification of a wave structure formed in one or more embodiments of a barrier packaging film; and

FIGS. 12A, 12B and 12C are enlarged micrographs of the top view of films which formed waves (12A and 12C) and a comparative film that does not form waves (12B). The micrographs illustrated in FIGS. 12A, 12B and 12C are not at the same magnification.

The drawings show some but not all embodiments. The elements depicted in the drawings are illustrative and not necessarily to scale, and the same (or similar) reference numbers denote the same (or similar) features throughout the drawings.

### DETAILED DESCRIPTION

The barrier packaging film structure according to the present invention includes at least one heat-shrinkable polyolefin substrate layer, at least one inorganic coating layer and at least one polymeric buffer layer, the polymeric buffer layer being in direct contact with the inorganic coating layer and positioned between the polyolefin substrate layer and the inorganic coating layer. During exposure to temperatures high enough to cause the packaging film to shrink, the buffer layer is configured to be a malleable interface between the shrinking substrate layer and the stiff, non-shrinking inorganic coating layer, allowing a continuous wave structure to form within the inorganic coating layer at the surface of the at least one polymeric buffer layer. In some embodiments, formation of the continuous wave structure substantially reduces the number of cracks within the inorganic coating layer. In some embodiments, formation of the continuous wave structure, and more particularly, the shrinking substrate layer, mitigates the loss of oxygen and water vapor barrier.

In some embodiments, the wave structure formation effect of the inorganic layer on the buffer layer is obtained by a subtle equilibrium between 1) polymeric buffer layer thickness, 2) elastic modulus of the polymeric buffer material at the heat treatment temperature and 3) the thickness of the inorganic layer. At and above the temperature at which the substrate layer begins to shrink (i.e., the heat treatment temperature), the buffer layer must have a modulus such that it can change shape. The shape change is a result of a shrinking surface area on the side of the buffer layer nearest the shrinking substrate layer and the non-shrinking surface area on the side of the buffer layer adjacent the inorganic coating layer. Due to its low modulus, the surface of the buffer layer adjacent to the substrate layer can move and adjust to the shrinking force. The buffer layer adjacent to the inorganic layer conforms to a wave structure to accommodate for the unchanging surface area of the inorganic coating layer. The wave structure of the inorganic coating may form in one or more patterns including but not limited to regular (i.e., stripes), herringbone and random (i.e., labyrinths). The formation of the wave structure allows the inorganic coating layer to flex, retaining its original surface area and remaining intact, without cracks (or without as many cracks), and reducing or eliminating the degradation of the barrier properties of the inorganic coating layer that can occur due to shrinking of the substrate layer.

Without limiting the current invention, a model used to describe the theoretical formation of waves in various systems can be found in Huang, Z Y, Hong, W, Suo Z 2005, ‘Nonlinear Analysis of Wrinkles in a Film Bonded to a Compliant Substrate’, Journal of the Mechanics and Physics of Solids, 53, 2101-2118.

Embodiments of the present invention advantageously describe formation of the wave structure and retention of barrier properties as polyolefin-based packaging structures are developed. It is believed that the packaging industry is moving toward more sustainable options, including streamlining of the materials used into narrow categories. For example, one option is to design packaging structures with high polyolefin content in order to categorize the films as recyclable. Elimination of non-olefinic polymers from the packaging structures often presents deficiencies in the overall performance of the packaging structure. In the case of packaging intended for heat treatment applications such as retort or pasteurization, polyolefin polymers are more sensitive to the application temperatures. Specifically, at high temperatures, polyolefin materials can shrink more than other polymeric materials and may become unsuitable as a structural component for an inorganic coating layer. The introduction of a buffer layer concept as described herein into the packaging film can reduce the negative effects of utilizing a more recyclable set of polymer materials. As a result, the barrier packaging films described herein are more easily recyclable due to the high polyolefin content yet retain the high performance attributes such as oxygen and moisture barrier.

“Polymeric Buffer Layer” as used herein is a layer within the barrier packaging film, directly adjacent to and in contact with the inorganic coating layer, having the function of allowing the inorganic coating layer to flex from a relatively flat cross-sectional geometry into a wave structure. The polymeric buffer layer is formulated such that the material or blend of materials becomes malleable in the temperature range at which the barrier packaging film experiences slight shrinking due to thermal exposure (e.g., 95° C.), as is further described herein. The formula of the polymeric buffer layer can be directed toward achieving an elastic modulus in the appropriate temperature range that allows the material to be pliable.

As used herein, layers or films that are “in direct contact with” or “are directly adjacent to” each other have no intervening material between them.

“Inorganic Coating Layer” as used herein refers to a layer that comprises a metal layer or an oxide coating layer. The inorganic coating layer act as a barrier layer. The inorganic coating layer may be vacuum deposited (i.e., vacuum coated, vapor coated, vacuum metalized) directly on the surface of the buffer layer. Alternatively, the inorganic coating layer may be deposited by wet chemistry methods, such as solution coating.

As described herein, the polyolefin substrate layer may be oriented. Orientation may be the result of monoaxially oriented (machine direction or transverse direction), or biaxially oriented (machine direction and transverse direction) stretching of the barrier packaging film, increasing the machine direction and/or transverse direction dimension and subsequently decreasing the thickness of the material. Biaxial orientation may be imparted to the film simultaneously or successively. In some embodiments, the film stretched in either or both directions at a temperature just below the melt temperature of the polymers in the film. In this manner, the stretching causes the polymer chains to “orient”, changing the physical properties of the film. At the same time, the stretching thins the film. The resulting oriented films are thinner and can have significant changes in mechanical properties such as toughness, heat resistance, stiffness, tear strength and barrier. Orientation is typically accomplished by a double- or triple-bubble process, by a tenter-frame process or an MDO process using heated rolls. A typical blown film process does impart some stretching of the film, but not enough to be considered oriented as described herein. An oriented film may be heat set (i.e., annealed) after orientation, such that the film is relatively dimensionally stable under elevated temperature conditions that might be experienced during conversion of the retort film laminate (i.e., printing or laminating) or during the use of the laminate (i.e., heat sealing or retort sterilization). As used herein, the terms “unoriented” and “non-oriented” refer to a monolayer or multilayer film, sheet or web that is substantially free of post-extrusion orientation.

As used herein, the term “polyolefin” generally includes polypropylene and polyethylene polymers.

As used throughout this application, the term “copolymer” refers to a polymer product obtained by the polymerization reaction or copolymerization of at least two monomer species. The term “copolymer” is also inclusive of the polymerization reaction of three, four or more monomer species having reaction products referred to terpolymers, quaterpolymers, etc.

As used throughout this application, the term “polypropylene” or “PP” refers to, unless indicated otherwise, propylene homopolymers or copolymers. Such copolymers of propylene include copolymers of propylene with at least one alpha-olefin and copolymers of propylene with other units or groups. The term “polypropylene” or “PP” is used without regard to the presence or absence of substituent branch groups or other modifiers. Polypropylene includes, but is not limited to, homopolymer polypropylene, polypropylene impact copolymer, polypropylene random copolymer, propylene-ethylene copolymers, ethylene-propylene copolymers, maleic anhydride grafted polypropylenes and blends of such. Various polypropylene polymers may be recycled as reclaimed polypropylene or reclaimed polyolefin.

As used throughout this application, the term “polyethylene” or “PE” refers to, unless indicated otherwise, ethylene homopolymers or copolymers. Such copolymers of ethylene include copolymers of ethylene with at least one alpha-olefin and copolymers of ethylene with other units or groups such as vinyl acetate, acid groups, acrylate groups, or otherwise. The term “polyethylene” or “PE” is used without regard to the presence or absence of substituent branch groups. Polyethylene includes, but is not limited to, medium density polyethylene, high density polyethylene, low density polyethylene, linear low-density polyethylene, ultra-low density polyethylene, ethylene alpha-olefin copolymer, ethylene vinyl acetate, ethylene acid copolymers, ethylene acrylate copolymers, neutralized ethylene copolymers such as ionomer, maleic anhydride grafted polyethylene and blends of such. Various polyethylene polymers may be recycled as reclaimed polyethylene or reclaimed polyolefin.

As used throughout this application, the term “polyester” or “PET” refers to a homopolymer or copolymer having an ester linkage between monomer units. The ester linkage may be represented by the general formula [O—R—OC(O)—R′—C(O)]n where R and R′ are the same or different alkyl (or aryl) group and may generally be formed from the polymerization of dicarboxylic acid and diol monomers.

As used herein, the term “polyamide” refers to a high molecular weight polymer having amide linkages (—CONH—)n which occur along the molecular chain and includes “nylon” resins which are well known polymers having a multitude of uses including utility as packaging films. Examples of nylon polymeric resins for use in food packaging and processing include: nylon 66, nylon 610, nylon 66/610, nylon 6/66, nylon 11, nylon 6, nylon 66T, nylon 612, nylon 12, nylon 6/12, nylon 6/69, nylon 46, nylon 6-3-T, nylon MXD-6, nylon MXDI, nylon 12T and nylon 6I/6T. Examples of polyamides include nylon homopolymers and copolymers such as nylon 4,6 (poly(tetramethylene adipamide)), nylon 6 (polycaprolactam), nylon 6,6 (poly(hexamethylene adipamide)), nylon 6,9 (poly(hexamethylene nonanediamide)), nylon 6,10 (poly(hexamethylene sebacamide)), nylon 6,12 (poly(hexamethylene dodecanediamide)), nylon 6/12 (poly(caprolactam-co-dodecanediamide)), nylon 6,6/6 (poly(hexamethylene adipamide-co-caprolactam)), nylon 66/610 (e.g., manufactured by the condensation of mixtures of nylon 66 salts and nylon 610 salts), nylon 6/69 resins (e.g., manufactured by the condensation of epsilon-caprolactam, hexamethylenediamine and azelaic acid), nylon 11 (polyundecanolactam), nylon 12 (polylauryllactam) and copolymers or mixtures thereof. Polyamide is used in films for food packaging and other applications because of its unique physical and chemical properties. Polyamide is selected as a material to improve temperature resistance, abrasion resistance, puncture strength and/or barrier of films. Properties of polyamide-containing films can be modified by selection of a wide variety of variables including copolymer selection, and converting methods (e.g., coextrusion, orientation, lamination, and coating).

As used herein, “polyurethane” is generally referencing polymers having organic units joined by urethane links (—NH—(C═O)—O—).

As used herein, “polylactic acid” is a polymer made from lactic acid and having a backbone of [—C(CH₃)HC(═O)O—]ₙ.

As used throughout this application, the term “vinyl alcohol copolymer” refers to film forming copolymers of vinyl alcohol (CH₂CHOH). Examples include, but are not limited to, ethylene vinyl alcohol copolymer (EVOH), butenediol vinyl alcohol copolymer (BVOH), and polyvinyl alcohol (PVOH).

As used throughout this application, the term “ethylene vinyl alcohol copolymer”, “EVOH copolymer” or “EVOH” refers to copolymers comprised of repeating units of ethylene and vinyl alcohol. Ethylene vinyl alcohol copolymers may be represented by the general formula: [(CH₂—CH₂)ₙ—(CH₂—CH(OH))]ₙ. Ethylene vinyl alcohol copolymers may include saponified or hydrolyzed ethylene vinyl acetate copolymers. EVOH refers to a vinyl alcohol copolymer having an ethylene co-monomer and prepared by, for example, hydrolysis of vinyl acetate copolymers or by chemical reactions with vinyl alcohol. Ethylene vinyl alcohol copolymers may comprise from 28 mole percent (or less) to 48 mole percent (or greater) ethylene.

The term “layer”, as used herein, refers to a building block of a film that is a structure of a single material type or a homogeneous blend of materials. A layer may be a single polymer, a blend of materials within a single polymer type or a blend of various polymers, may contain metallic materials and may have additives. Layers may be continuous with the film or may be discontinuous or patterned. A layer has an insignificant thickness (z direction) as compared to the length and width (x-y direction), and therefore is defined to have two major surfaces, the area of which are defined by the length and width of the layer. An exterior layer is one that is connected to another layer at only one of the major surfaces. In other words, one major surface of an exterior layer is exposed. An interior layer is one that is connected to another layer at both major surfaces. In other words, an interior layer is between two other layers. A layer may have sub-layers.

Similarly, the term “film”, as used herein, refers to a web built of layers and/or films, all of which are directly adjacent to and connected to each other. A film can be described as having a thickness that is insignificant as compared to the length and width of the film. A film has two major surfaces, the area of which are defined by the length and width of the film.

As used herein, the term “exterior” is used to describe a film or layer that is located on one of the major surfaces of the film in which it is comprised. As used herein, the term “interior” is used to describe a film or layer that is not located on the surface of the film in which it is comprised. An interior film or layer is adjacent to another film or layer on both sides.

“Wave structure” as used herein refers to a cross-sectional geometry of the inorganic coating layer and the surface of the adjacent polymeric buffer layer(s). As with any wave, the wave structure has a wavelength, measurable in the x-y direction, and an amplitude, measurable in the z-direction.

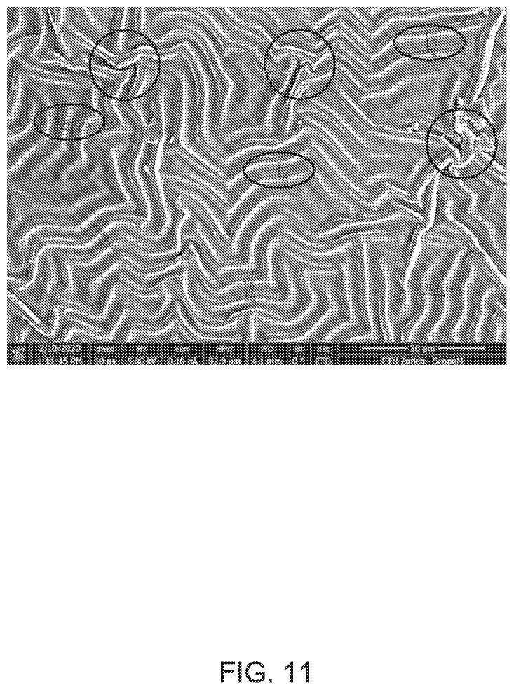

The wavelength of the wave structure can be determined using top view microscopy techniques including, but not limited to, optical microscopy, laser scanning microscopy, electron microscopy, or atomic force microscopy. The resolution of the microscope needs to be sufficient to identify features on the waves, such as wave peaks and wave valleys. An example of a representative top view microscopy is shown in FIG. 11. As shown in this view, the waves take various patterns and are organized into wave domains, or sections where the waves are regular and ordered. The wave domains meet at corners or edges and form irregular folds or intersections. Measurements of the waves can be executed in the wave domains, examples of which are indicated by superimposed ovals. Variations in wave measurements can occur at the intersections, examples of which are indicated by superimposed circles, as the colliding waves interfere with the regular pattern. The areas including intersections of waves are not used for wave measurements.

The wavelength is the distance between either peak to peak or valley to valley in an undistorted area of waves (i.e., wave domain). An average wavelength is calculated by taking the average of at least 5 individual wavelength measurements.

Other techniques to determine the wavelength are possible. For example, the wavelength may be measured using a cross-sectional view of the wave structure. Another option would be to measure it in an optical setup, using the waves as a grating. The resulting spectrum of a light shining through the film may be used to determine the wavelength.

The amplitude of a wave structure (i.e., the distance from valley to peak of a wave) can be assessed on a film using a z-direction information sensitive microscope. For example, the microscope may be a laser scanning microscope or an atomic force microscope. In some embodiments, the resolution in the z-direction may be at least as small as the tens of nanometers range.

In some embodiments of the film, the amplitude can be determined on a cut cross-section (i.e., microtome cut, embedded in epoxy and polished, or other routes) in a microscope with appropriate resolution and contrast. As the shrink in a laminate containing many layers is generally less than shrink in a film containing only a polyolefin substrate, a polymeric buffer layer and an inorganic coating layer, the amplitude may be lower in said film.

As used herein, the “average amplitude” is determined by measurement of the amplitude of at least five individual waves using one or more positions across the film sample in undistorted areas (i.e., wave domains) and calculating the average of these five measurements.

As used herein, “barrier” or “barrier film” or “barrier layer” or “barrier material” refers to providing for reduced transmission to gases such as oxygen (i.e., containing an oxygen barrier material). The barrier material may provide reduced transmission to moisture (i.e., containing a moisture barrier material). The barrier characteristic may be provided by one or more barrier materials, or a blend of multiple barrier materials. The barrier layer may provide the specific barrier required to preserve the product within a package throughout an extended shelf-life which may be several months or even more than one year.

The barrier may reduce the influx of oxygen through the barrier packaging film during the shelf-life of a packaged product (i.e., while the package is hermetically sealed). The oxygen transmission rate (OTR) of the barrier packaging film is an indication of the barrier provided and can be measured according to ASTM F1927 using conditions of 1 atmosphere, 23° C. and 50% RH.

As used herein, a “barrier packaging film” or “hermetically sealed package” or “retort stable package” is a film, or package made from the film, that maintains a high oxygen or moisture barrier level with little degradation after exposure to, at, or above the heat treatment temperature. The packages may be filled with product, sealed, and remain hermetically sealed, thus maintaining excellent barrier properties.

As used herein, the “Young's modulus” or “elastic modulus” or “modulus” is a measure of a materials ability to change dimension when under tensile or compressive force, in units of force per unit area. A material with a higher Young's modulus may be relatively stiff while a material with a lower Young's modulus is relative soft and pliable (i.e., elastic). Young's modulus can be calculated from a force-displacement data set derived from a nanoindentation test procedure.

“Free Shrink” as used herein is an unrestrained linear shrinkage that a film or layer undergoes due to exposure to elevated temperature. The shrink is irreversible and relatively rapid (i.e., evident within seconds or minutes). Free shrink is expressed as a percentage of the original dimension, (i.e., 100×(pre-shrink dimension−post-shrink dimension)/(pre-shrink dimension)). Free shrink can be measured using ASTM D2732. Alternatively, free shrink can be measured by using the test method described in ASTM D2732 with a modification of using hot air as the heating source instead of a hot fluid bath. If using the hot air method, the unrestrained sample is placed in an oven set at the specified temperature for a time span of at least 1 minute, giving the oven interior and sample ample time to come to thermal equilibrium.

As used herein, “ASTM E2546-15 Annex X.4” refers to an instrumented indentation test procedure according to the documented standard using an apparatus including a silicon tip mounted on a silicon cantilever with a defined tip radius of 30 nm.

The barrier packaging films described herein may be useful as retort or pasteurization packaging films. As used herein, a “retort packaging film” or “retort packaging” is a film, or package made from the film, that can be filled with product, sealed, and remain hermetically sealed after being exposed to a typical retort sterilization process. Typical retort sterilization is a batch process that uses temperatures in a range of from about 100° C. to about 150° C., overpressure up to about 70 psi (483 kPa), and may have a duration from a few minutes up to several hours. Common retort processes used for products packaged in flexible films include steam or water immersion. Food or other products packaged in retort packaging film and retort sterilized can be stored at ambient conditions for extended periods of time (i.e., are shelf-stable), retaining sterility. Because the retort process degrades the films, or packages made from the films, very specialized flexible packaging films have been designed to survive the retort process.

It was surprisingly found that a film structure could be developed to incorporate the formation of a wave structure in the inorganic coating layer upon heating of the film structure. Upon heating, the film structure maintained the performance properties necessary for these films to be used in packaging applications and other similar uses. For instance, the layers necessary for wave formation were also able to include necessary bonding to adjacent layers, have appropriate flexibility and clarity, and provide durability through other environmental conditions beyond thermal exposure (i.e., flexing, puncture, humidity, etc.).

As used herein, the term “adhesive layer” refers to a layer which has a primary function of bonding two adjacent layers together. The adhesive layers may be positioned between two layers of a multilayer film to maintain the two layers in position relative to each other and prevent undesirable delamination. Unless otherwise indicated, an adhesive layer can have any suitable composition that provides a desired level of adhesion with the one or more surfaces in contact with the adhesive layer material.

As used herein, the term “sealing layer” refers to a layer of a film, sheet, etc., involved in the sealing of the film, sheet, etc., to itself and/or to another layer of the same or another film, sheet, etc. As used herein, the terms “heat seal”, “heat sealed”, “heat sealing”, “heat sealable”, and the like, refer to both a film layer which is heat sealable to itself or other thermoplastic film layer, and the formation of a fusion bond between two polymer surfaces by conventional indirect heating means. It will be appreciated that conventional indirect heating generates sufficient heat on at least one film contact surface for conduction to the contiguous film contact surface such that the formation of a bond interface therebetween is achieved without loss of the film integrity.

As used herein, the term “printed indicia layer” refers to a layer or series of sub-layers that have been printed onto a film. The layer or sub-layers may include pigment containing materials (i.e., colored ink), protective layers (i.e., over-lacquer) and ink receptive primers. Over-lacquer may protect a printed pigment layer and may improve the appearance of surface the film. Each of the printed indicia layer(s) may be independently continuous with the other layers of the film or independently discontinuous (i.e., patterned). Specifically, a printed indicia layer may include one or more continuous sub-layers of white pigmented print and one or more patterned sub-layers including other colors, thus producing the visible graphics for the packaging film. Printing of the printed indicia layer may be done by any known printing method including, but not limited to, flexographic gravure printing, rotogravure printing, gravure coating, and digital printing methods. Sub-layers within the printed indicia layer may be applied by the same process or using different types of processes.

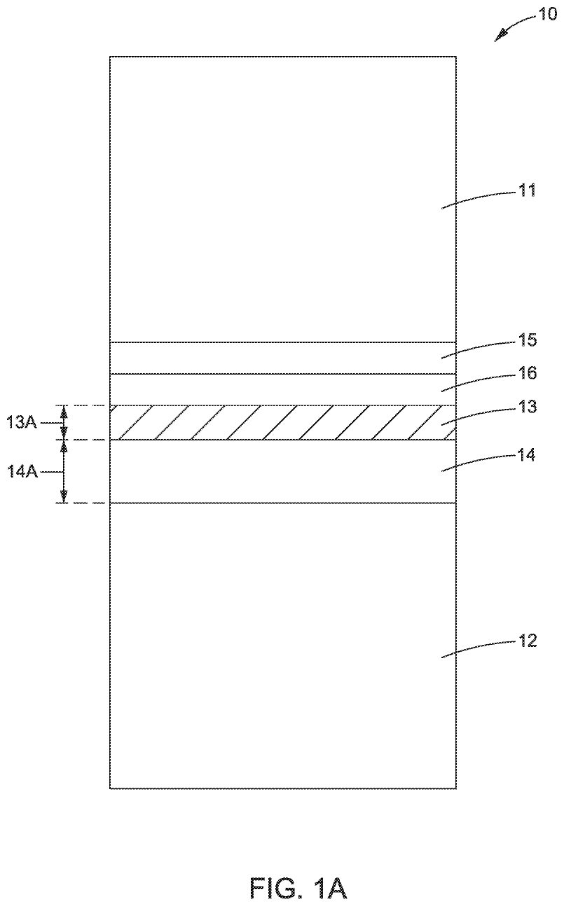

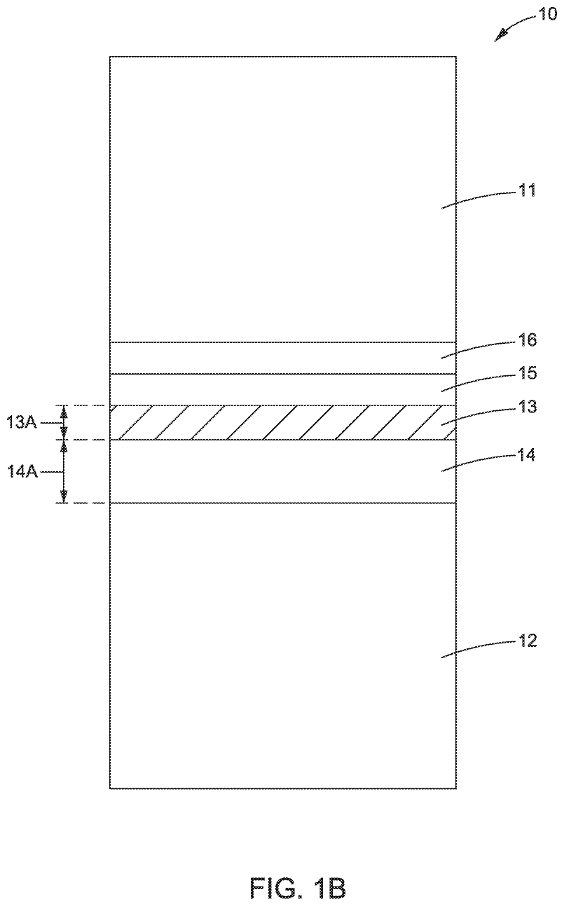

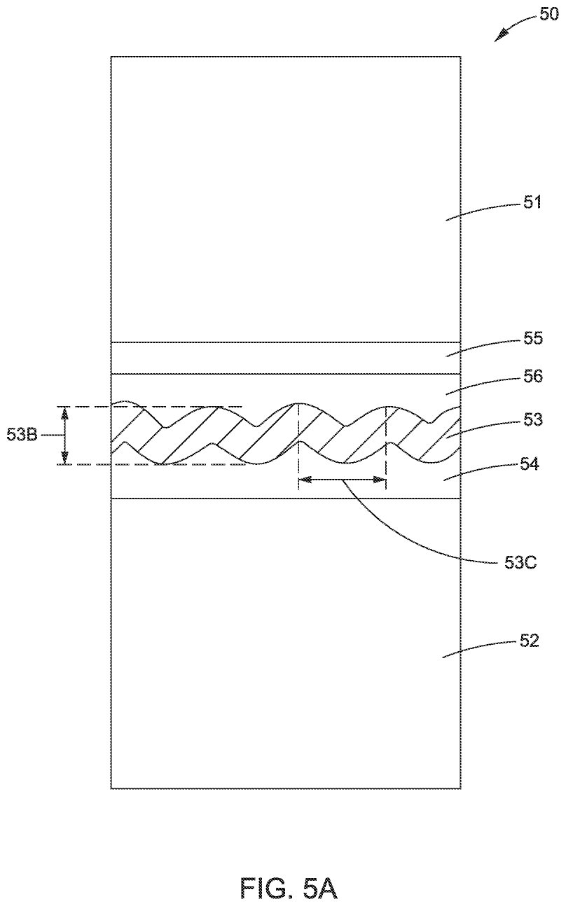

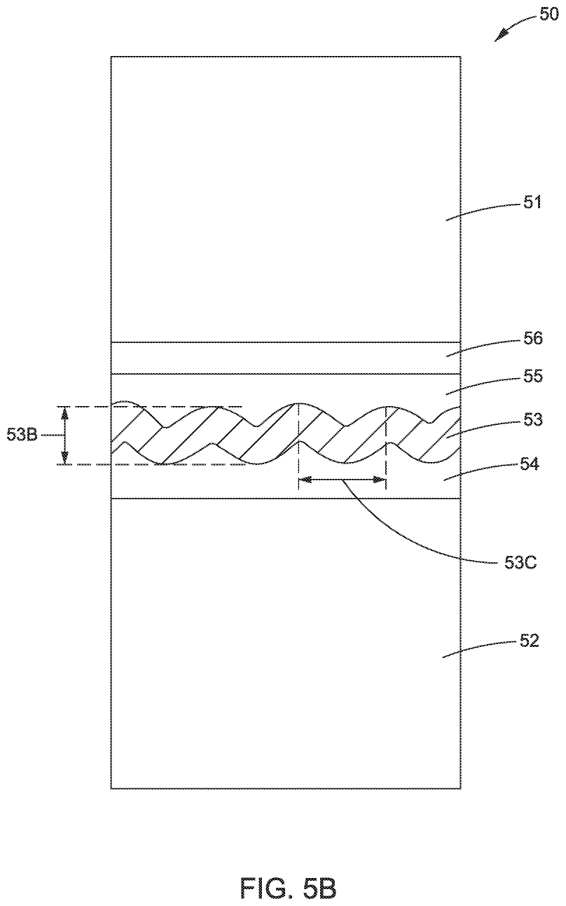

As mentioned, the printed indicia layer may include one or more sub-layers that contains white pigmented print. Typically, the white pigment of the printing ink comprises titanium dioxide (TiO₂) particles. The TiO₂ particles can cause disruptions in the formation of the wave structure if they are located near the inorganic oxide coating. Embodiments of the barrier packaging film may include one or more layers between the inorganic oxide coating layer and a printed indicia layer that contains TiO₂ particles. There may be other printed indicia layer sub-layers (e.g., non-white colored sub-layers, primer sub-layers) between the sub-layer containing TiO₂ particles and the inorganic oxide coating layer. There may be an adhesive layer between the layer containing TiO₂ and the inorganic oxide coating layer, such as the embodiments illustrated in FIGS. 1B and 5B. In any of the embodiments, the one or more layers between the TiO₂ particle containing layer and the inorganic oxide coating should have a combined thickness greater than or equal to the average amplitude of the wave formation.

We now turn to the specific details of an embodiment of a structure of a barrier packaging film. FIG. 1A shows a cross-sectional view of a barrier packaging film 10. The barrier packaging film 10 includes a polyolefin substrate 12, an inorganic coating layer 13 and a polymeric buffer layer 14 positioned between the polyolefin substrate 12 and the inorganic coating layer 13. The polymeric buffer layer 14 is in direct contact with the inorganic coating layer 13. The polymeric buffer layer 14 may be in direct contact with the polyolefin substrate 12, as shown in FIG. 1A, or there may be one or more additional layers between the polymeric buffer layer 14 and the polyolefin substrate 12. In some embodiments, the barrier packaging film 10 also includes a polyolefin sealing layer 11, a printed indicia layer 16 and an adhesive layer 15. The polyolefin substrate 12 forms an exterior layer of the barrier packaging film 10 and the polyolefin sealing layer 11 forms the opposing exterior layer of the barrier packaging film 10.

Embodiments of the barrier packaging film that include a printed indicia layer directly adjacent to the inorganic coating layer may include sub-layers within the printed indicia layer. A sub-layer of a primer may be directly adjacent to the inorganic coating layer, followed by one or more pigment containing sub-layers. The primer containing sub-layer may be a continuous layer. The primer containing sub-layer may act as a second buffer layer, as will be discussed below.

In a further alternative embodiment, FIG. 1B shows a cross-sectional view of a similar barrier packaging film 10. Here, the location of the printed indicia layer 16 and the adhesive layer 15 have been exchanged. The embodiment illustrated in FIG. 1B shows that either the polyolefin substrate 12/polymeric buffer layer 14/inorganic coating layer 13 combination can be printed or the polyolefin sealing layer 11 can be printed prior to the lamination step. In yet another embodiment (not shown), both sections could be printed prior to lamination.

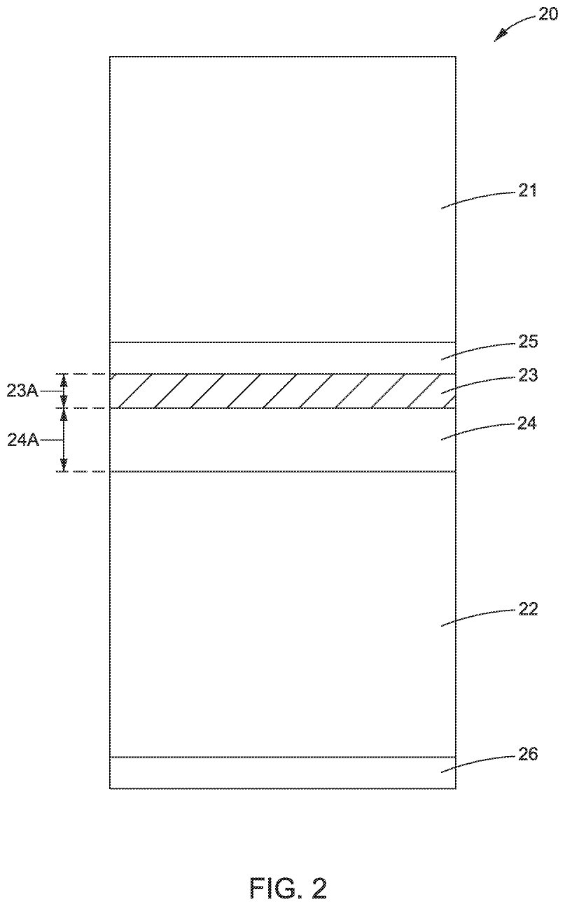

FIG. 2 illustrates a cross-sectional view of a specific embodiment of a barrier packaging film 20. In FIG. 2, the barrier packaging film 20 includes a polyolefin substrate 22, an inorganic coating layer 23 and a polymeric buffer layer 24 positioned between the polyolefin substrate 22 and the inorganic coating layer 23. The polymeric buffer layer 24 is in direct contact with the inorganic coating layer 23. The polymeric buffer layer 24 may be in direct contact with the polyolefin substrate 22, as shown in FIG. 2, or there may be one or more additional layers between the polymeric buffer layer 24 and the polyolefin substrate 22. In some embodiments, the barrier packaging film 20 also includes a polyolefin sealing layer 21, a printed indicia layer 26 and an adhesive layer 25. The printed indicia layer 26 forms an exterior layer of the barrier packaging film 20 and the polyolefin sealing layer 21 forms the opposing exterior layer of the barrier packaging film 20. In this location, the printed indicia layer 26 may include a heat resistant overlacquer sub-layer for the purposes of protecting the pigmented layers from scuffing and exposure to thermal sources. The advantage gained in this embodiment is that a plain (unprinted) film lamination can be produced at large scale, and then smaller portions of the film can be printed with specific graphics for each packaging application. This can avoid significant amounts of scrap material during the packaging film production process.

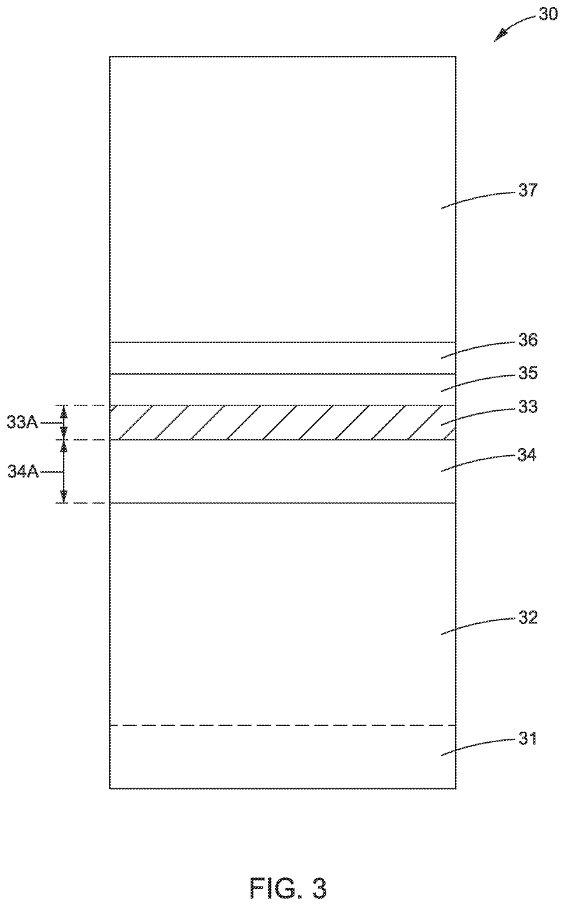

FIG. 3 illustrates a cross-sectional view of another embodiment of a barrier packaging film 30. In this embodiment, the barrier packaging film 30 includes a polyolefin substrate 32, an inorganic coating layer 33 and a polymeric buffer layer 34 positioned between the polyolefin substrate 32 and the inorganic coating layer 33. The polymeric buffer layer 34 is in direct contact with the inorganic coating layer 33. The polymeric buffer layer 34 may be in direct contact with the polyolefin substrate 32, as shown in FIG. 3, or there may be one or more additional layers between the polymeric buffer layer 34 and the polyolefin substrate 32. In some embodiments, the barrier packaging film 30 also includes a polyolefin sealing layer 31, an oriented exterior layer 37, a printed indicia layer 36 and an adhesive layer 35. In some embodiments, the polyolefin sealing layer 31 is part of (i.e., is a sub-layer of) the polyolefin substrate 32. The oriented exterior layer 37 is formed from polyolefin and forms an exterior layer of the barrier packaging film 30. The polyolefin sealing layer 31 forms the opposing exterior layer of the barrier packaging film 30.

An example of a barrier packaging film 30 that is represented by FIG. 3, includes BOPP (37)/printed indicia (36)/adhesive (35)/SiOx (33)/PU buffer (34)/multilayer MDOPP (32), wherein the MDOPP (32) film contains an exterior layer (31) that contains polypropylene materials suitable for heat sealing.

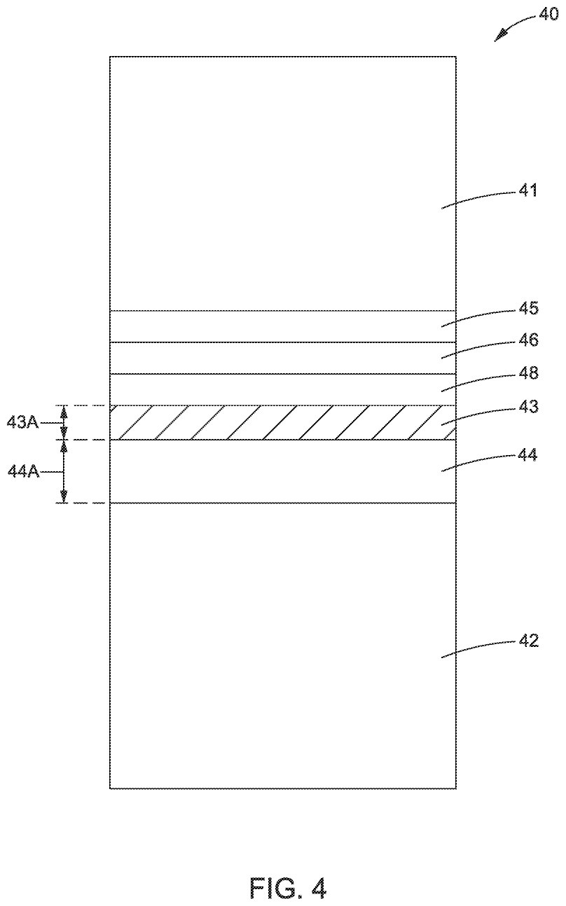

FIG. 4 illustrates a cross-sectional view of another embodiment of a barrier packaging film 40. In FIG. 4 the barrier packaging film 40 includes a polyolefin substrate 42, an inorganic coating layer 43 and a polymeric buffer layer 44 positioned between the polyolefin substrate 42 and the inorganic coating layer 43. The polymeric buffer layer 44 is in direct contact with the inorganic coating layer 43. In some embodiments, the polymeric buffer layer 44 may be in direct contact with the polyolefin substrate 42, as shown in FIG. 4, or there may be one or more additional layers between the polymeric buffer layer 44 and the polyolefin substrate 42. In some embodiments, the barrier packaging film 40 also includes a polyolefin sealing layer 41, a printed indicia layer 46, an adhesive layer 45 and a second polymeric buffer layer 48. The polyolefin substrate 42 forms an exterior layer of the barrier packaging film 40 and the polyolefin sealing layer 41 forms the opposing exterior layer of the barrier packaging film 40. In some embodiments, the second polymeric buffer layer 48 is in direct contact with the inorganic coating layer 43, opposite the first polymeric buffer layer 44. In some embodiments, the second polymeric buffer layer 48 has the same properties as the first polymeric buffer layer 44 in regard to content, thickness and physical properties. In some embodiments, the second polymeric buffer layer 48 has different properties as compared to the first polymeric buffer layer 44. The extra buffer layer is important in structures where both the polyolefin substrate and the polyolefin sealing layer exhibit shrink properties at elevated temperatures.

In some embodiments, the polyolefin substrate has a free shrink value greater than zero in at least one of the machine direction or the transverse direction at 95° C. The free shrink of the polyolefin substrate at 95° C., or another elevated processing temperature which the barrier packaging film is exposed, causes a decrease in the surface area of the polyolefin substrate. It is believed that any layer adjacent to or near the shrinking polyolefin substrate experiences a shrink force in the x-y direction, due to the reduction of surface area.

The free shrink of the polyolefin substrate at 95° C. may be in a range of from 0.5% to 10%, in a range of from 0.5% to 8%, in a range of from 1% and 10% or in a range of from 1% to 6%. The free shrink of the polyolefin substrate may be measured on the polyolefin substrate alone (including any sublayers that may be present). Alternatively, the free shrink of the polyolefin substrate may be measured on a combination of the polyolefin substrate and the polymeric buffer layer, plus any intervening layers, together. The free shrink of the polyolefin substrate may be measured when the polyolefin substrate is connected to the inorganic coating layer, including the polymeric buffer layer and any other intervening layers.

The polyolefin substrate comprises any polymer including, but not limited to, polyethylene, polypropylene or blends of these polymers. The polyolefin substrate may comprise any number of sublayers. The sublayers of the polyolefin substrate may include polymers within the same polymer class (i.e., all layers are various types of polypropylene polymers) or the sublayers may be of different polymer classes. The polyolefin substrate may be oriented or non-oriented. The polyolefin substrate may be relatively clear, translucent, or opaque. The polyolefin substrate may have printed indicia deposited on either of its major surfaces.

The polyolefin substrate may be a film and the film may be produced by any known process, for example blown film or cast film. The polyolefin substrate may be a monoaxially oriented polypropylene film (MDOPP), a biaxially oriented polypropylene film (BOPP), a monoaxially oriented polyethylene film (MDOPE), or a biaxially oriented polyethylene film (BOPE). The polyolefin substrate may be produced using specific polymers and may be oriented using specific conditions which optimize the heat resistance of the film.

The polyolefin substrate may have a thickness (prior to shrinking) in a range of from 6 μm to 100 μm. In some embodiments, the polyolefin substrate may have a thickness in a range of from 10 μm to 50 μm, or in a range of from 10 μm to 30 μm.

The inorganic coating layer of the barrier packaging film may be a metal or inorganic oxide that has been applied by a vacuum deposition process, such as chemical vapor deposition or physical vapor deposition. Alternatively, the inorganic coating layer may be applied using a wet chemistry technique. The inorganic coating layer is deposited on the surface of the polymeric buffer layer. The inorganic coating layer is directly adjacent to and in direct contact with the polymeric buffer layer.

The inorganic coating layer provides a significant contribution to the oxygen barrier (OTR reduction) to the barrier packaging film. The inorganic coating layer may be transparent oxide coating such as AlOx (i.e., aluminum oxide) or SiOx (i.e., silicon oxide). The oxide coating may be produced by a vacuum deposition process.

The inorganic coating layer may include a metal layer such as aluminum or a blend of aluminum and another metal. The metal layer may be produced by a vacuum deposition process.

Referring to FIGS. 1A, 1B, 2, 3 and 4 again, the inorganic coating layer 13, 23, 33, 43 has a thickness 13A, 23A, 33A, 43A measured in the z-direction. The inorganic coating layer 13, 23, 33, 43 has a thickness 13A, 23A, 33A, 43A in a range of from 0.005 μm to 0.1 μm, in a range of from 0.005 μm to 0.06 μm, in a range of from 0.01 μm to 0.1 μm or in a range of from 0.01 μm to 0.06 μm. An inorganic coating layer having thickness greater than these ranges may result in a layer that is not able to flex into the wave structure to accommodate the surface area change without cracking or otherwise failing.

In some embodiments, the polymeric buffer layer of the barrier packaging film is located between the polyolefin substrate and the inorganic coating layer. In some embodiments, the polymeric buffer layer is in direct contact with the inorganic coating layer. The polymeric buffer layer may be in direct contact with the polyolefin substrate. The polymeric buffer layer may be a sub-layer within a film that also contains the polyolefin substrate. In some embodiments of the barrier packaging film, there may be intervening layers between the polymeric buffer layer and the polyolefin substrate.

Without limiting, embodiments of the polymeric buffer layer may include polymers such as vinyl alcohol copolymer, polyurethane-based polymer, polypropylene-based polymer, polylactic acid-based polymer, blends of these polymers or blends of these materials with other materials. Again, without limiting, the polymeric buffer layer may be produced by coating, extrusion, coextrusion or lamination. The buffer layer may have an intrinsic barrier property (oxygen or moisture barrier), that may contribute to the overall barrier property of the barrier packaging film.

Referring to FIGS. 1A, 1B, 2, 3 and 4 again, the polymeric buffer layer 14, 24, 34, 44 has a thickness 14A, 24A, 34A, 44A measured in the z-direction. The polymeric buffer layer 14, 24, 34, 44 has a thickness 14A, 24A, 34A, 44A in a range of from 0.5 μm to 12 μm, in a range of from 1 μm to 5 μm, or in a range of from 1 μm to 2.5 μm.

The ratio of the thickness of the polymeric buffer layer of the barrier packaging film to the thickness of the inorganic coating layer of the barrier packaging film is in a range of from 20 to 500, or in a range of from 30 to 120. A ratio of thicknesses within this range is one of the combination of factors that allow for formation of a wave structure in the inorganic coating layer upon shrinking of the polyolefin substrate.

The polymeric buffer layer has a Young's modulus in a range of from 0.1 MPa to 100 MPa at an elevated temperature, such as 95° C. This property of the polymeric buffer layer, in conjunction with the location and thickness of the polymeric buffer layer among other details of the film structure, advantageously allows for the formation of the wave structure in the inorganic coating layer as the polyolefin substrate shrinks, preventing cracking and loss of barrier properties.

The polyolefin sealing layer may comprise polyolefin materials. The sealing layer may comprise a formula of polymers designed to reduce the heat seal initiation temperature to compliment the heat resistance of the opposite exterior layer. Even though the sealing layer may have a rather low temperature softening point, the sealing layer may have enough integrity to survive the high temperatures of the retort sterilization process along with other abuses a package may endure during distribution and use.

In some embodiments, the sealing layer of the barrier packaging film has a composition that will allow the formation of a heat seal, thus forming a hermetic package. As used herein, the term “heat seal” or “heat sealed” refers to two or more surfaces that have been bonded together by application of both heat and pressure for a short period of time, or by way of an ultrasonic energy sealing process. Heat sealing and ultrasonic sealing are well-known and commonly used processes for creating packages and are familiar to those skilled in the art.

The sealing layer is necessarily on the surface of the barrier packaging film in order to facilitate the function of sealing. During use of the barrier packaging film in a package, the sealing layer may be heat sealed to itself or another packaging component. During heat sealing, the sealing layer softens, allowing formation of a heat seal bond, at a sealing temperature that is lower than the temperature resistance of the opposite exterior layer of the barrier packaging film. The sealing layer softens at a sealing temperature that is lower than the temperature resistance of the opposite exterior layer. It is believed that the sealing layer softens and forms a heat seal at sealing conditions (time, temperature and pressure) that do not cause excessive shrinking or marring on the exterior surface of the barrier packaging film.

The barrier packaging film is targeted to contain high amounts of polyolefin, specifically polypropylene or polyethylene, such that the barrier packaging film may be acceptable for a recycling process. Polyolefins have relatively low heat resistance as compared to materials traditionally used for packaging films (i.e., polyester, aluminum foil, polyamide). As a result of the lower heat resistance, the packages will be formed using a heat-sealing process with lower temperatures to avoid any shrinking or burn through. The challenge met by the barrier packaging films disclosed herein is to incorporate a sealing layer that has a low heat-seal initiation temperature (HSIT) and a high seal strength and seal toughness to survive both retort or pasteurization processing and normal distribution and handling (i.e., drop strength and burst strength). In some embodiments, the sealing layer also contains materials that are approved for food contact during retort conditions, as dictated by governmental agencies for food safety.

The sealing layer may contain a material that has a low heat seal initiation temperature (HSIT). In some embodiments of the retort packaging film, the sealing layer contains a polypropylene copolymer having a melt temperature equal to or less than 135° C.

The barrier packaging film may have an overall thickness from about 63.5 μm to about 254 μm, or from about 76.2 μm to about 152.4 μm.

While the structure of the barrier packaging film and any packages made therefrom contain several different elements (sealing layer, polyolefin substrate, inorganic coating layer, buffer layer, etc.) the total composition of the film or package should have high levels of a single material type (polyolefin or specifically, polypropylene or polyethylene) to facilitate recycling. As used herein, the term “total composition” is used to describe the entire film structure or package. Any materials, layers or components that are connected to one another in any way are part of the total composition of that article. The barrier packaging films may have high levels of polyolefin-based polymers. The packaging films may have high levels of polypropylene-based polymers. The packaging films may have high levels of polyethylene-based polymers. The packaging films described herein, and any packages made therefrom, may be recyclable in a polypropylene recycling process when the article contains high amounts of polypropylene-based polymers. The packaging films described herein, and any packages made therefrom, may be recyclable in a polyethylene recycling process when the article contains high amounts of polyethylene-based polymers. A mixed polyolefin recycling process can also accept relatively high levels of polyolefins present in the packaging films described herein, and any packages made therefrom.

The barrier packaging films described herein may have a total composition that contains at least 80%, at least 85% or at least 90% polyolefin-based polymers by weight, promoting recyclability of the film and/or package in which it is used. Materials that are not polyolefin-based polymers are minimized. For example, the inorganic coating layer of the barrier packaging film is a material that is not a polyolefin-based material and thus is provided in as thin of a layer as possible to function properly as a barrier. The film may also have other non-polyolefin materials, such as those located in the adhesive layer and the printed indicia layer.

In specific embodiments of the barrier packaging films, the film has a total composition that contains at least 80%, at least 85% or at least 90% polypropylene-based polymers by weight. In specific embodiments of the barrier packaging films, the film has a total composition that contains at least 80%, at least 85% or at least 90% polyethylene-based polymers by weight.

Using the combination of film structure design elements as described herein, a more heat durable barrier packaging film can be achieved. The films may be suitable to be recycled in a polyolefin-based recycling process because of the high polyolefin content. The films may have low levels (i.e., 55%, by weight) of, or may be essentially free from, materials such as polyester, polyamide, chlorine containing polymers and aluminum foil. The films may contain non-polyolefin-based polymers such as those used in adhesive layers or ink layers, but the amount of non-polyolefin-based polymers is minimized and generally comprises less than 10% of the overall composition or less than 5% of the overall composition, by weight. The films may contain non-polymeric materials such as barrier materials, but the amount of non-polymeric materials is minimized and generally comprises less than 10% of the overall composition or less than 5% of the overall composition, by weight.

As previously described herein, an increase in environmental temperature may cause the polyolefin substrate to shrink slightly in one or more directions. As the temperature rises, the polymeric material softens, releasing tension that may have been embedded in the layer upon production. The tension release may result in a movement and rearrangement of the polymer chains and an ultimate change (increase or decrease) in the dimensions of the layer. A common result of increasing temperature on a polyolefin substrate is a slight reduction (i.e., shrink) of the substrate in at least one direction parallel with the x-y plane of the layer.

Upon shrinking of the polyolefin substrate, a compressive force is applied to the other layers within the barrier packaging film with the largest force being applied to the adjacent layers. The other layers may also have a shrinking tendency at the elevated temperature, and it is likely that the free shrink of each layer is slightly different. The greatest difference in free shrink is likely found when comparing any polymeric layer to the inorganic coating layer of the barrier packaging film. Most inorganic coatings experience no shrink at the temperatures at which the polyolefin substrate will shrink (e.g., 95° C. or some other temperature). Additionally, inorganic coatings also have very high modulus (high stiffness) at these elevated temperatures.

Using the defined structure of one or more embodiments of the barrier packaging films described herein, upon experiencing an elevated temperature, the polyolefin substrate, and possibly other layers of the structure, will begin to shrink. In some embodiments, the closely located polymeric buffer layer, having a low modulus at the elevated temperature, experiences the x-y direction compressive force and conforms to the stress easily. The surface of the polymeric buffer layer may become slightly denser or the polymeric buffer layer may become slightly thicker (z-direction) as the surface area (x-y direction) of the polyolefin substrate decreases and the material polymeric buffer layer is compressed. The inorganic coating layer, however, is not pliable (i.e., has high modulus and high stiffness). As a result of the x-y direction compressive forces from the shrinking polyolefin substrate, and the low modulus of the underlying (i.e., directly adjacent) polymeric buffer layer, the inorganic coating layer may have a tendency bend into a pattern of waves, the amplitude of the waves forming in the z-direction. The formation of the wave structure preserves the surface area of the inorganic coating layer, preventing the typical cracks that would normally form under the shrink forces in the absence of an appropriate polymeric buffer layer.

The cross-sectional view shown in FIG. 5A illustrates a barrier packaging film 50 which is identical to that shown in FIG. 1A, with the exception that the inorganic coating layer has now taken on a wave formation. In other words, the barrier packaging film 10 of FIG. 1A has been exposed to elevated temperatures, inducing shrink in the polyolefin substrate. The barrier packaging film 50 includes a polyolefin substrate 52, an inorganic coating layer 53 and a polymeric buffer layer 54 positioned between the polyolefin substrate 52 and the inorganic coating layer 53. In some embodiments, the polymeric buffer layer 54 is in direct contact with the inorganic coating layer 53. The polymeric buffer layer 54 may be in direct contact with the polyolefin substrate 52, as shown in FIG. 5A, or there may be one or more additional layers between the polymeric buffer layer 54 and the polyolefin substrate 52. In some embodiments, the barrier packaging film 50 also includes a polyolefin sealing layer 51, a printed indicia layer 56 and an adhesive layer 55. In some embodiments, the polyolefin substrate 52 forms an exterior layer of the barrier packaging film 50 and the polyolefin sealing layer 51 forms the opposing exterior layer of the barrier packaging film 50.

The cross-sectional view shown in FIG. 5B illustrates a barrier packaging film 50 which is identical to that shown in FIG. 1B, with the exception that the inorganic coating layer has now taken on a wave formation. In other words, the barrier packaging film 10 of FIG. 1B has been exposed to elevated temperatures, inducing shrink in the polyolefin substrate. As compared to FIG. 5A, the location of the printed indicia layer 56 and the adhesive layer 55 have been exchanged.

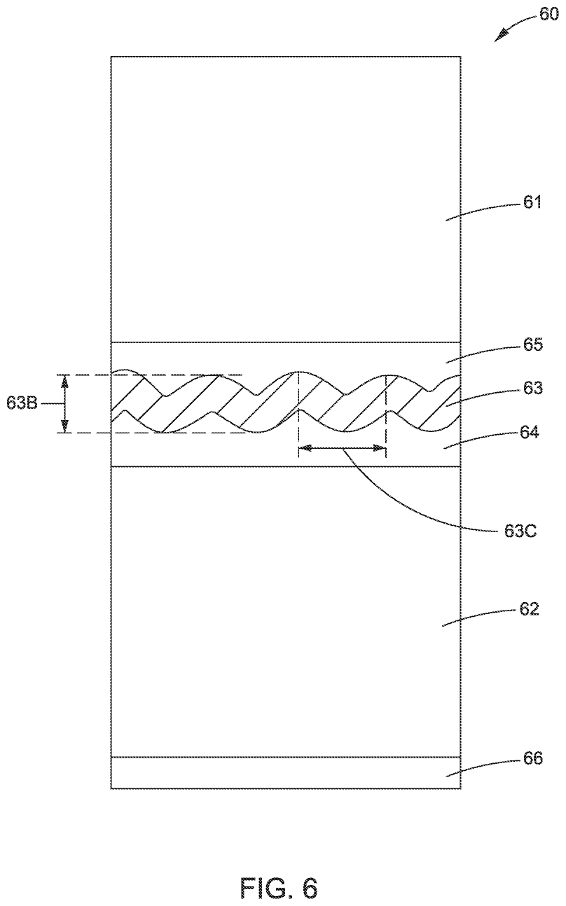

The cross-sectional view shown in FIG. 6 illustrates a barrier packaging film 60 which is identical to that shown in FIG. 2, with the exception that the inorganic coating layer has now taken on a wave formation. In other words, the barrier packaging film 20 of FIG. 2 has been exposed to elevated temperatures, inducing shrink in the polyolefin substrate. In FIG. 6, the barrier packaging film 60 includes a polyolefin substrate 62, an inorganic coating layer 63 and a polymeric buffer layer 64 positioned between the polyolefin substrate 62 and the inorganic coating layer 63. In some embodiments, the polymeric buffer layer 64 is in direct contact with the inorganic coating layer 63. The polymeric buffer layer 64 may be in direct contact with the polyolefin substrate 62, as shown in FIG. 6, or there may be one or more additional layers between the polymeric buffer layer 64 and the polyolefin substrate 62. In some embodiments, the barrier packaging film 60 also includes a polyolefin sealing layer 61, a printed indicia layer 66 and an adhesive layer 65. In some embodiments, the printed indicia layer 66 forms an exterior layer of the barrier packaging film 60 and the polyolefin sealing layer 61 forms the opposing exterior layer of the barrier packaging film 60.

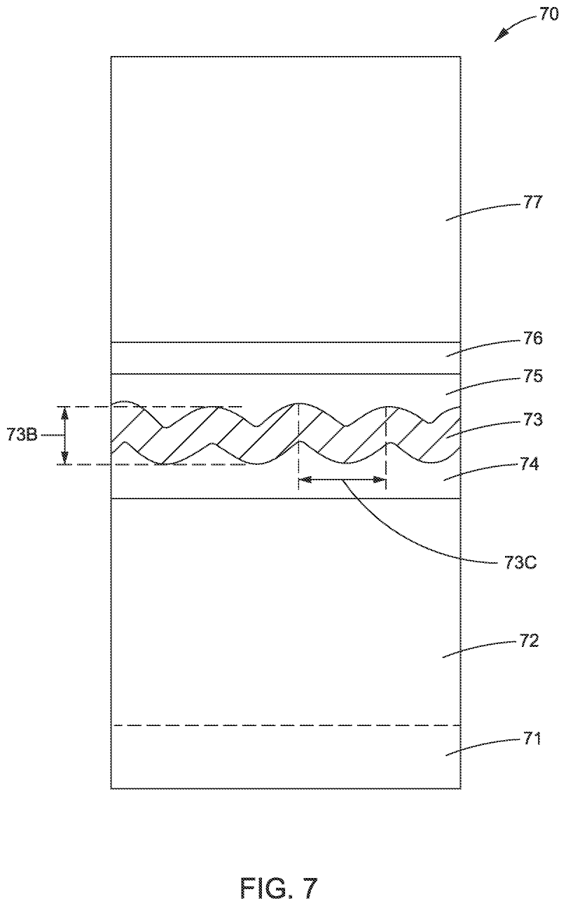

The cross-sectional view shown in FIG. 7 illustrates a barrier packaging film 70 which is identical to that shown in FIG. 3, with the exception that the inorganic coating layer has now taken on a wave formation. In other words, the barrier packaging film 30 of FIG. 3 has been exposed to elevated temperatures, inducing shrink in the polyolefin substrate. In this embodiment, the barrier packaging film 70 includes a polyolefin substrate 72, an inorganic coating layer 73 and a polymeric buffer layer 74 positioned between the polyolefin substrate 72 and the inorganic coating layer 73. In some embodiments, the polymeric buffer layer 34 is in direct contact with the inorganic coating layer 73. The polymeric buffer layer 74 may be in direct contact with the polyolefin substrate 72, as shown in FIG. 7, or there may be one or more additional layers between the polymeric buffer layer 74 and the polyolefin substrate 72. In some embodiments, the barrier packaging film 70 also includes a polyolefin sealing layer 71, an oriented exterior layer 77, a printed indicia layer 76 and an adhesive layer 75. In some embodiments, the polyolefin sealing layer 71 is part of (i.e., is a sub-layer of) the polyolefin substrate 72. In some embodiments, the oriented exterior layer 77 is formed from polyolefin and forms an exterior layer of the barrier packaging film 70. In some embodiments, the polyolefin sealing layer 71 forms the opposing exterior layer of the barrier packaging film 70.

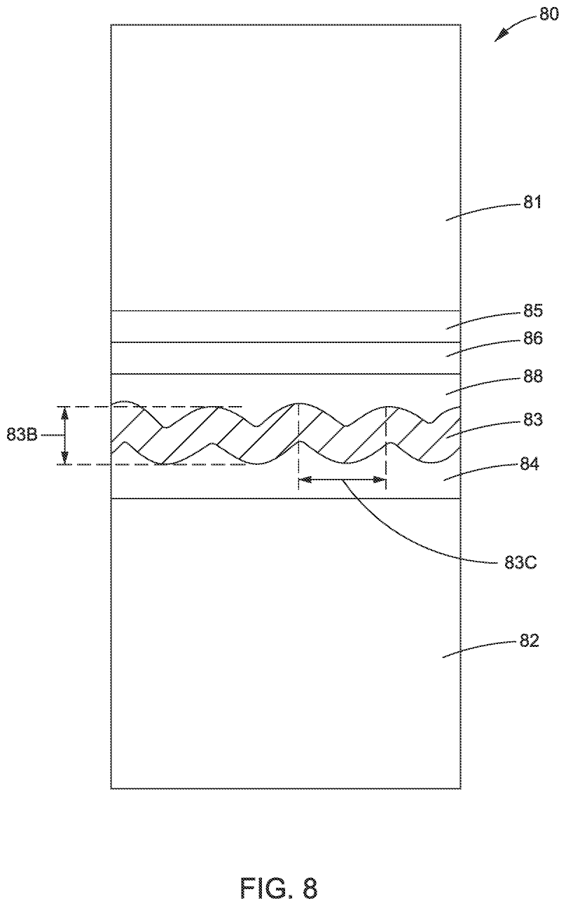

The cross-sectional view shown in FIG. 8 illustrates a barrier packaging film 80 which is identical to that shown in FIG. 4, with the exception that the inorganic coating layer has now taken on a wave formation. In other words, the barrier packaging film 40 of FIG. 4 has been exposed to elevated temperatures, inducing shrink in the polyolefin substrate. In FIG. 8, the barrier packaging film 80 includes a polyolefin substrate 82, an inorganic coating layer 83 and a polymeric buffer layer 84 positioned between the polyolefin substrate 82 and the inorganic coating layer 83. In some embodiments, the polymeric buffer layer 84 is in direct contact with the inorganic coating layer 83. The polymeric buffer layer 84 may be in direct contact with the polyolefin substrate 82, as shown in FIG. 8, or there may be one or more additional layers between the polymeric buffer layer 84 and the polyolefin substrate 82. In some embodiments, the barrier packaging film 80 also includes a polyolefin sealing layer 81, a printed indicia layer 86, an adhesive layer 85 and a second polymeric buffer layer 88. In some embodiments, the polyolefin substrate 82 forms an exterior layer of the barrier packaging film 80 and the polyolefin sealing layer 81 forms the opposing exterior layer of the barrier packaging film 80. In some embodiments, the second polymeric buffer layer 88 is in direct contact with the inorganic coating layer 83, opposite the first polymeric buffer layer 84. In some embodiments, the second polymeric buffer layer 88 has the same properties as the first polymer buffer layer 84 in regard to content, thickness and physical properties.

The wave structures shown in FIGS. 5A, 5B, 6, 7 and 8 are characterized by a wavelength 53C, 63C, 73C, 83C and amplitude 53B, 63B, 73B, 83B.

In some embodiments of the barrier packaging film in which the wave structure has been formed, the average amplitude of the wave structure may be in a range of from 0.25 μm to 1.0 μm or in a range of from 0.4 μm to 1.0 μm. The wavelength of the wave structure may be in a range of from 2 μm to 5 μm. The wave structure may also be characterized by a ratio of the wavelength to the average amplitude, the ratio in a range of from 2 to 20, or in a range of from 4 to 10.

In embodiments of the barrier packaging film that include a wave structure formed in the inorganic coating layer, the thickness of the polymeric buffer layer may be in a range of from 1.1 to 20 times the average amplitude of the wave structure. In some embodiments, the thickness of the polymeric buffer layer may be in a range of from 1.5 to 5 times the average amplitude of the wave structure.

When the barrier packaging film includes a wave structure formed in the inorganic coating layer, the thickness of the polymeric buffer layer is varying along the length of the wave. In this case, the thickness of the polymeric buffer layer is measured at the center point (i.e. of the wave, between the crest and the trough of the wave.

In some embodiments, before being exposed to elevated heat conditions, the barrier packaging film may have an average oxygen transmission rate (OTR) value that is less than or equal to 2 cm³/m²/day, less than or equal to 1 cm³/m²/day, less than or equal to 0.5 cm³/m²/day, or less than or equal to 0.1 cm³/m²/day (measured according to ASTM F1927 using conditions of 1 atmosphere, 23° C. and 50% RH). In some embodiments, after being exposed to a representative retort sterilization process, the barrier packaging film has an average OTR value that is less than or equal to 2 cm³/m²/day, less than or equal to 1 cm³/m²/day, less than or equal to 0.5 cm³/m²/day, or less than or equal to 0.1 cm³/m²/day. The average OTR value may be near, at, or below the minimum detection level of a testing device. The representative retort sterilization process is completed by cutting a DIN A4 sized portion of the packaging film and exposing it to a steam sterilization process for 60 minutes at 128° C. and overpressure of 2.5 bar, followed by water shower cooling.

The wave structure may be formed when the barrier packaging film is exposed to temperatures above 95° C. The wave structure may be formed in any type of process. For example, during or after the conversion of the barrier packaging film, the film may be heated by a roller or an oven. The roller should be heated to a temperature that is capable of raising the temperature the film, causing the wave formation to occur. This film can then be used in a packaging application or for another use. Alternatively, the barrier packaging film may be exposed to elevated temperatures during or after forming the material into a package, filling with product and hermetically sealing it closed. The elevated temperature may be part of a retort process or another type of pasteurization.

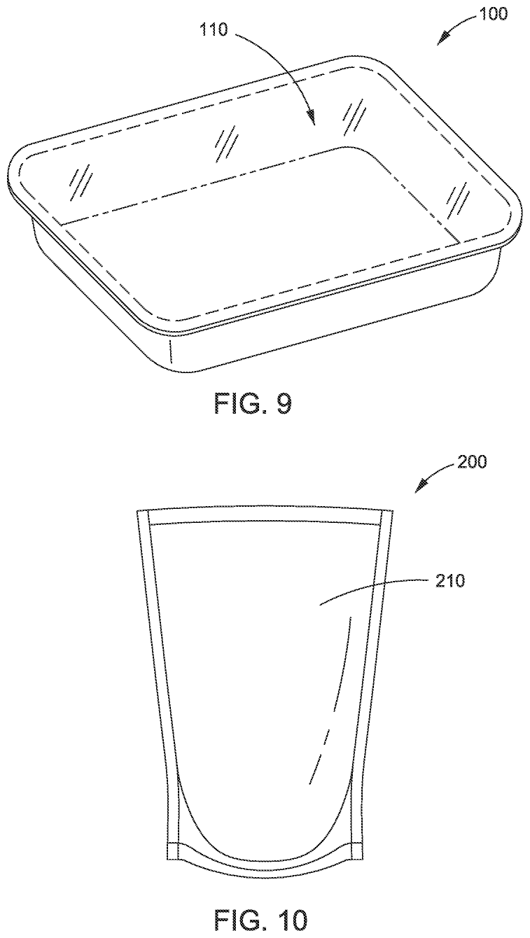

The barrier packaging film can be formed into packages, with or without other packaging components. For example, the barrier packaging film 210 can be formed into a flexible stand-up pouch 200 as shown in FIG. 10. In another embodiment of a hermetically sealed package 100, the barrier packaging film 95 may be a lid material sealed to a thermoformed tray or cup, as shown in FIG. 9.

The barrier packaging films disclosed herein maintain excellent barrier properties and visual appearance, even after the film has been formed into a package, filled, hermetically sealed and undergone the retort sterilization process.

The disclosure is now described with reference to the following examples.

### Examples and Data

Several film structures were produced as summarized in Table 1 below.

TABLE 1
Example and Comparative Example Film Structures

| | | Polypropylene |
|---|---|---|
| | | content, % |
| Identification | Structure | by weight |
| Example 1 | 18 μm BOPP / 1.7 μm PU / | 93.7% |
| | 0.04 μm SiOx / 3.5 μm adh / 60 | |
| | μm PP | |
| Example 2 | 18 μm BOPP / 1.7 μm PU / | 93.7% |
| | 0.03 μm aluminum / 3.5 μm | |
| | adh / 60 μm PP | |
| Example 3 | 19 μm BOPP with HS / 0.008 | 95.7% |
| | μm SiOx / 3.5 μm adh / 60 μm | |
| | PP | |
| Comparative | 19 μm BOPP with HS / 0.05 μm | 95.7% |
| Example 4 | SiOx / 3.5 μm adh / 60 μm PP | |
| Example 5 | 18 μm BOPP / 1.7 μm PU / | 92.9% |
| | 0.04 μm SiOx / 0.7 μm PU / 3.5 | |
| | μm adh / 60 μm PP | |
| Example 6 | 25 μm OPP / 1.7 μm PU / 0.03 | 94.2% |
| | μm SiOx / 3.5 μm adh / 60 μm | |
| | PP | |

The film structure of Example 1 was prepared by applying a water-based polyurethane (PU) dispersion to the surface of an 18 μm biaxially oriented polypropylene film to achieve a 1.7 μm coating after drying the dispersion. A silicon oxide coating (SiOx) was applied by vapor deposition to the surface of the PU coating. A 60 μm polypropylene sealing layer was then adhesively laminated to the silicon oxide coating.

The film structure of Example 2 was prepared by applying a water-based polyurethane (PU) dispersion to the surface of an 18 μm biaxially oriented polypropylene film to achieve a 1.7 μm coating after drying the dispersion. An aluminum coating was applied by vapor deposition to the surface of the PU coating. A 60 μm polypropylene sealing layer was then adhesively laminated to the aluminum coating.

The film structure of Example 3 and Comparative Example 4 were prepared by first depositing a silicon oxide coating layer onto the heat sealable surface of a 19 μm heat sealable biaxially oriented polypropylene (BOPP with HS). The heat sealable layer of the BOPP film was approximately 0.7 μm thick and is of a material that is appropriate for a buffer layer. Next, a 60 μm polypropylene sealing layer was adhesively laminated to the silicon oxide coating layer.

The film structure of Example 5 was prepared by applying a water-based polyurethane (PU) dispersion to the surface of an 18 μm biaxially oriented polypropylene film to achieve a 1.7 μm coating after drying the dispersion. A silicon oxide coating (SiOx) was applied by vapor deposition, to the surface of the PU coating. Next, an additional layer of the water-based PU dispersion was applied to the surface of the silicon oxide coating. A 60 μm polypropylene sealing layer was then adhesively laminated to the exposed PU buffer coating.

The film structure of Example 6 was prepared by applying a water-based polyurethane (PU) dispersion to the surface of a 25 μm heat stabilized biaxially oriented polypropylene film to achieve a 1.7 μm coating after drying the dispersion. A silicon oxide coating (SiOx) was applied by vapor deposition, to the surface of the PU coating. A 60 μm polypropylene sealing layer was then adhesively laminated to the silicon oxide coating.

For each of the Example structures and Comparative Example structures listed in Table 1, Table 2 lists the polyolefin substrate layer of the structure (or the equivalent thereof for the comparative example), and the free shrink of this layer at 95° C. Additionally, Table 2 lists the polymeric buffer layer of the structure (or the equivalent thereof for the comparative example), and the Young's modulus of the buffer layer material at 95° C.

TABLE 2
Free Shrink of Polyolefin Substrate Layer and Elevated
Temperature Young's Modulus of Polymeric Buffer Layer

| | | Free | | Young's |
|---|---|---|---|---|
| | Polyolefin Substrate | Shrink | Polymeric | Modulus |
| Identification | Layer | (%) | Buffer Layer | (MPa) |
| Example 1 | 18 μm BOPP | 2.9 | 1.7 μm PU | 25 |
| Example 2 | 18 μm BOPP | 2.9 | 1.7 μm PU | 25 |
| Example 3 | 19 μm BOPP | 1 | 19 μm BOPP | 90 |
| | with HS | | with HS | |
| Comp. | 19 μm BOPP | 1 | 19 μm BOPP | 90 |
| Example 4 | with HS | | with HS | |
| Example 5 | 18 μm BOPP | 2.9 | 1.7 μm PU & | 25 |
| | | | 0.7 μm PU | |
| Example 6 | 25 μm BOPP | 0.8 | 1.7 μm PU | 25 |

The Young's modulus data shown in Table 3 was collected using an atomic force microscopy (AFM) technique utilizing the PinPoint™ Mode on a Park Systems NX10 AFM. To determine the mechanical Young's modulus of the polymeric buffer layer, samples of the polyolefin substrate/polymeric buffer layer were mounted on a heating stage. The stage was heated to the appropriate test temperature. A silicon tip mounted on a silicon cantilever with a defined tip radius of 30 nm (SD-R30-FM, available from NanoAndMore GmbH) was used for force spectroscopy. Young's modulus was calculated from the resulting force-displacement curve.

For each of the Example structures and Comparative Example structures listed in Table 1, Table 3 contains the layer thickness ratio for the polymeric buffer layer and the inorganic coating layer.

TABLE 3
Ratio of Polymeric Buffer Layer Thickness
to Inorganic Coating Layer Thickness

| | Polymeric Buffer | Inorganic Coating | |
|---|---|---|---|
| | Layer Thickness | Layer Thickness | |
| Identification | (μm) | (μm) | Ratio |
| Example 1 | 1.7 | 0.04 | 42.5 |
| Example 2 | 1.7 | 0.03 | 56.7 |
| Example 3 | 0.7 | 0.008 | 87.5 |
| Comp. Example 4 | 0.7 | 0.05 | 14 |
| Example 5 | 1.7 | 0.04 | 42.5 |
| Example 6 | 1.7 | 0.03 | 56.7 |

Table 4 contains a summary of wave formation for the Example and Comparative Example structures. The structures were heated to a temperature above 95° C. and subsequently inspected for waves.

TABLE 4
Wave Formation in Examples and Comparative Examples

| | | | | | Ratio: Buffer | |
|---|---|---|---|---|---|---|
| | | | | | Layer | Ratio: Wave- |
| | | | Ave. | Wave- | Thickness/ | length/ |
| | Heating | Waves | Amp. | length | Ave. | Ave. |
| Identification | conditions | Present? | (nm) | (μm) | Amplitude | Amplitude |
| Example 1 | Retort, | Yes | 720 | 4.5 | 1.7/0.72 = | 4.5/0.72 = |
| | 127° C., 50 | | | | 2.36 | 6.25 |
| | minutes | | | | | |
| Example 2 | Exposure | Yes | N/A | N/A | N/A | N/A |
| | to 130° C., | | | | | |
| | 15 | | | | | |
| | minutes | | | | | |
| Example 3 | Retort, | Yes | N/A | 0.8 | N/A | N/A |
| | 127° C., 50 | | | | | |
| | minutes | | | | | |
| Comp. | Retort, | Yes | 550 | 4 | 0.7/0.55 = | 4/0.55 = |
| Example 4 | 127° C., 50 | | | | 1.27 | 7.3 |
| | minutes | | | | | |
| Example 6 | Retort, | Yes | N/A | 5.8 | N/A | N/A |
| | 127° C., 50 | | | | | |
| | minutes | | | | | |

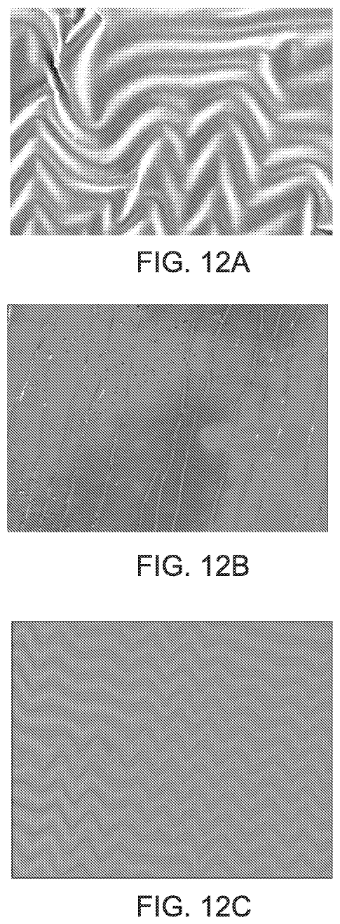

Top view micrographic photos of several film structures are shown in FIGS. 12A, 12B, and 12C, respectively. The film shown in FIG. 12A has a structure of 18 μm BOPP/1.7 μm PU/0.04 μm SiOx. The film shown in FIG. 12B has a structure of 18 μm BOPP/1.7 μm PU/0.05 μm SiOx. The film shown in FIG. 12C has a structure of 60 μm PP/3.5 μm adh/18 μm BOPP/1.7 μm PU/0.04 μm SiOx. The polyurethane dispersion used in the structure shown in FIG. 12B has a very high Young's Modulus (over 900 MPa) at 95° C. and therefore does not meet the necessary conditions for wave formation. Note that the three micrographic photos illustrated in FIGS. 12A, 12B, and 12C were not taken at the same magnification and do not show relative wave characteristics. Rather, the micrographic photos show clear wave formation of various patterns (FIGS. 12A and 12C) and an example of no wave formation, including clear cracks in the inorganic coating layer (FIG. 12B).

The result of the wave formation on the barrier performance of the film structures is evident from the data of Tables 5a and 5b. The films that are designed to allow for wave formation upon heating and shrinking of the film have significantly less oxygen barrier loss (less OTR increase).

TABLE 5a
Average Oxygen Transmission Data for Example
and Comparative Example Structures

| | OTR* - before | OTR* - after | Ratio: after/ |
|---|---|---|---|
| Identification | heating | heating | before |
| Example 1 | 0.1 | 0.5 | 5 |
| Example 2 | 0.1 | 0.18 | 1.8 |
| Example 3 | 33.7 | 63.7 | 1.9 |
| Comp. | 3.54 | 149.3 | 42 |
| Example 4 | | | |
| Example 5 | 0.07 | 0.16 | 2.3 |
| Example 6 | 0.1 | 0.6 | 6 |

*OTR units are cm³/(m² 24 h bar) measured by ASTM 3985-2005, using 23° C. and 50% rh.

TABLE 5b
Moisture Transmission Data for Example
and Comparative Example Structures

| | MVTR ** - | MVTR ** - | Ratio: after/ |
|---|---|---|---|
| Identification | before heating | after heating | before |
| Example 1 | 0.5 | 1.4 | 2.8 |
| Example 2 | 0.9 | 2 | 2.2 |
| Example 3 | 3.2 | 3.1 | 1 |
| Comp. | 0.71 | 2.5 | 3.5 |
| Example 4 | | | |
| Example 5 | 0.73 | 0.93 | 1.3 |
| Example 6 | 0.19 | 1 | 5.2 |

*WVTR units are g/(m² 24 h bar) measured by ASTM F 1249-90 Using 38° C. and 90% rh.

### Embodiments

Embodiment 1: A barrier packaging film comprising: a polyolefin substrate, the polyolefin substrate comprising a free shrink in the range of from 0.5% to 10% in at least one of the machine direction and the transverse direction at 95° C. according to ASTM D2732, an inorganic coating layer having a thickness in the range of from 0.005 micron to 0.1 micron, a polymeric buffer layer positioned between and in direct contact with each of the polyolefin substrate and the inorganic coating layer, the polymeric buffer layer comprising a thickness in the range of from 0.5 microns to 12 microns, and a polyolefin sealing layer, wherein there is a ratio of the thickness of the polymeric buffer layer to the thickness of the inorganic coating layer, the ratio in the range of from 20 to 500; and wherein the polymeric buffer layer comprises a Young's Modulus in the range of 0.1 MPa to 100 MPa, as calculated from measurements collected at 95° C., according to ASTM E2546-15 with Annex X.4.

Embodiment 2: The barrier packaging film according to Embodiment 1 further comprising an adhesive layer, wherein: the polyolefin substrate is a first exterior layer, the polyolefin sealing layer is a second exterior layer, and the adhesive layer is located between the polyolefin sealing layer and the inorganic coating layer.

Embodiment 3: The barrier packaging film according to Embodiment 2 further comprising a printed indicia layer located between the polyolefin sealing layer and the inorganic coating layer.

Embodiment 4: The barrier packaging film according to Embodiment 1 further comprising a printed indicia layer and an adhesive layer, wherein: the printed indicia layer is a first exterior layer, the polyolefin sealing layer is a second exterior layer, and the adhesive layer is located between the polyolefin sealing layer and the inorganic coating layer.

Embodiment 5: The barrier packaging film according to one of any previous embodiment, wherein the polyolefin substrate is an oriented polypropylene film and the polyolefin sealing layer is a polypropylene sealing layer.

Embodiment 6: The barrier packaging film according to Embodiment 5 wherein the oriented polypropylene film comprises a homopolymer polypropylene.

Embodiment 7: The barrier packaging film according to one of Embodiments 1 through 4, wherein the polyolefin substrate is an oriented polyethylene film and the polyolefin sealing layer is a polyethylene sealing layer.

Embodiment 8: The barrier packaging film according to Embodiment 1 further comprising an oriented polyolefin exterior layer and an adhesive layer, wherein: the polyolefin sealing layer is a sublayer of the polyolefin substrate, and the adhesive layer is located between the oriented polyolefin exterior layer and the inorganic coating layer.

Embodiment 9: The barrier packaging film according to Embodiment 8 further comprising a printed indicia layer located between the oriented polyolefin exterior layer and the inorganic coating layer.

Embodiment 10: The barrier packaging film according to one of any previous embodiment, wherein the barrier packaging film has a total composition including greater than or equal to 80% polyolefin, by weight.

Embodiment 11: The barrier packaging film according to one of any previous embodiment, wherein the polyolefin substrate comprises a thickness in the range of from 10 microns to 100 microns.

Embodiment 12: The barrier packaging film according to one of any previous embodiment, wherein the polymeric buffer layer comprises a thickness in the range of from 1 μm to 5 μm.

Embodiment 13: The barrier packaging film according to one of any previous embodiment, wherein the inorganic coating layer comprises a metal layer or an oxide coating layer and the thickness of the inorganic coating layer is in the range of from 0.005 μm to 0.06 μm.

Embodiment 14: The barrier packaging film according to one of any previous embodiment, wherein the ratio of the thickness of the polymeric buffer layer to the thickness of the inorganic coating layer is in the range of from 30 to 120.

Embodiment 15: The barrier packaging film according to one of any previous embodiment, wherein the polymeric substrate comprises a free shrink of in the range of from 1% to 6% at 95° C. according to ASTM D2732.

Embodiment 16: The barrier packaging film according to one of any previous embodiment, wherein the polymeric buffer layer comprises vinyl alcohol copolymer, polypropylene-based polymer, polyurethane-based polymer or polylactic acid.

Embodiment 17: The barrier packaging film according to one of any previous embodiment, further comprising a second polymeric buffer layer in direct contact with the inorganic coating layer.

Embodiment 18: A barrier packaging film comprising: a polyolefin substrate, an inorganic coating layer, a polymeric buffer layer positioned between the polyolefin substrate and the inorganic coating layer, the polymeric buffer layer in direct contact with the inorganic coating layer, and a polyolefin sealing layer, wherein the inorganic coating layer comprises a wave structure characterized by an average amplitude in the range of from 0.25 μm to 1.0 μm and a wavelength in the range of from 2 μm to 5 μm, and the polymeric buffer layer comprises a thickness in the range of from 1.1 to 20 times the average amplitude of said wave structure.

Embodiment 19: The barrier packaging film according to Embodiment 18 further comprising an adhesive layer, wherein: the polyolefin substrate is a first exterior layer, the polyolefin sealing layer is a second exterior layer, and the adhesive layer is located between the polyolefin sealing layer and the inorganic coating layer.

Embodiment 20: The barrier packaging film according to Embodiment 19 further comprising a printed indicia layer located between the polyolefin sealing layer and the inorganic coating layer.

Embodiment 21: The barrier packaging film according to Embodiment 18 further comprising a printed indicia layer and an adhesive layer, wherein: the printed indicia layer is a first exterior layer, the polyolefin sealing layer is a second exterior layer, and the adhesive layer is located between the polyolefin sealing layer and the inorganic coating layer.

Embodiment 22: The barrier packaging film according to any one of Embodiments 18 through 21, wherein the polyolefin substrate is an oriented polypropylene film and the polyolefin sealing layer is a polypropylene sealing layer.

Embodiment 23: The barrier packaging film according to Embodiment 22 wherein the oriented polypropylene film comprises a homopolymer polypropylene.

Embodiment 24: The barrier packaging film according to any one of Embodiments 18 through 21, wherein the polyolefin substrate is an oriented polyethylene film and the polyolefin sealing layer is a polyethylene sealing layer.

Embodiment 25: The barrier packaging film according to Embodiment 18 further comprising an oriented polyolefin exterior layer and an adhesive layer, wherein: the polyolefin sealing layer is a sublayer of the polyolefin substrate, and the adhesive layer is located between the polyolefin exterior layer and the inorganic coating layer.

Embodiment 26: The barrier packaging film according to Embodiment 25 further comprising a printed indicia layer located between the polyolefin exterior layer and the inorganic coating layer.

Embodiment 27: The barrier packaging film according to any one of Embodiments 18 through 26 wherein the barrier packaging film has a total composition including greater than or equal to 80% polyolefin, by weight.

Embodiment 28: The barrier packaging film according to any one of Embodiments 18 through 27 wherein the polyolefin substrate comprises a thickness in the range of from 10 microns to 100 microns.

Embodiment 29: The barrier packaging film according to any one of Embodiments 18 through 28 wherein the polymeric buffer layer comprises a thickness in the range of from 1 to 5 μm.

Embodiment 30: The barrier packaging film according to any one of Embodiments 18 through 29, wherein the inorganic coating layer comprises a metal layer or an oxide coating layer and a thickness of the inorganic coating layer is in the range of from 0.005 μm to 0.06 μm.

Embodiment 31: The barrier packaging film according to any one of Embodiments 18 through 30 wherein the ratio of the thickness of the polymeric buffer layer to the thickness of the inorganic coating layer is in the range of from 30 to 120.

Embodiment 32: The barrier packaging film according to any one of Embodiments 18 through 31 wherein the wave structure of the inorganic layer is characterized by a ratio of the wavelength to the average amplitude, the ratio in the range of from 2 to 20.

Embodiment 33: The barrier packaging film according to any one of Embodiments 18 through 32 wherein the polymeric buffer layer comprises vinyl alcohol copolymer, polypropylene-based polymer, polyurethane-based polymer or polylactic acid.

Embodiment 34: The barrier packaging film according to any one of Embodiments 18 through 33 further comprising a second polymeric buffer layer in direct contact with the inorganic coating layer.

Embodiment 35: A hermetically sealed package comprising a barrier packaging film according to any one of Embodiments 1 through 34.

Embodiment 36: A barrier packaging film according to any one of the previous barrier packaging film embodiments that include a printed indicia layer and an inorganic coating layer comprising a wave structure, wherein the printed indicia layer includes a sub-layer containing TiO₂ particles, and wherein there is at least one layer located between the sub-layer containing TiO₂ particles and the inorganic coating layer and the at least one layer located between the sub-layer containing TiO₂ particles and the inorganic coating layer has a combined thickness greater than or equal to the average amplitude of the wave formation.

1. A barrier packaging film comprising:
a polyolefin substrate, the polyolefin substrate comprising a free shrink in the range of from 0.5% to 10% in at least one of the machine direction and the transverse direction at 95° C. according to ASTM D2732,
an inorganic coating layer having a thickness in the range of from 0.005 micron to 0.1 micron,
a polymeric buffer layer positioned between and in direct contact with each of the polyolefin substrate and the inorganic coating layer, the polymeric buffer layer comprising a thickness in the range of from 0.5 microns to 12 microns, and
a polyolefin sealing layer,
wherein there is a ratio of the thickness of the polymeric buffer layer to the thickness of the inorganic coating layer, the ratio in the range of from 20 to 500; and
wherein the polymeric buffer layer comprises a Young's Modulus in the range of 0.1 MPa to 100 MPa, as calculated from measurements collected at 95° C., according to ASTM E2546-15 with Annex X.4.

2. The barrier packaging film according to claim 1 further comprising an adhesive layer, wherein:
the polyolefin substrate is a first exterior layer,
the polyolefin sealing layer is a second exterior layer, and
the adhesive layer is located between the polyolefin sealing layer and the inorganic coating layer.

3. (canceled)

4. The barrier packaging film according to claim 1 further comprising a printed indicia layer and an adhesive layer, wherein:
the printed indicia layer is a first exterior layer,
the polyolefin sealing layer is a second exterior layer, and
the adhesive layer is located between the polyolefin sealing layer and the inorganic coating layer.

5. The barrier packaging film according to claim 1, wherein the polyolefin substrate is an oriented polypropylene film and the polyolefin sealing layer is a polypropylene sealing layer.

6. The barrier packaging film according to claim 5, wherein the oriented polypropylene film comprises a homopolymer polypropylene.

7. (canceled)

8. The barrier packaging film according to claim 1 further comprising an oriented polyolefin exterior layer and an adhesive layer, wherein:
the polyolefin sealing layer is a sublayer of the polyolefin substrate, and
the adhesive layer is located between the oriented polyolefin exterior layer and the inorganic coating layer.

9. (canceled)

10. The barrier packaging film according to claim 1, wherein the barrier packaging film has a total composition including greater than or equal to 80% polyolefin, by weight.

11. The barrier packaging film according to claim 1, wherein the polyolefin substrate comprises a thickness in the range of from 10 microns to 100 microns.

12. The barrier packaging film according to claim 1, wherein the polymeric buffer layer comprises a thickness in the range of from 1 μm to 5 μm.

13. The barrier packaging film according to claim 1, wherein the inorganic coating layer comprises a metal layer or an oxide coating layer and the thickness of the inorganic coating layer is in the range of from 0.005 μm to 0.06 μm.

14. The barrier packaging film according to claim 1, wherein the ratio of the thickness of the polymeric buffer layer to the thickness of the inorganic coating layer is in the range of from 30 to 120.

15. The barrier packaging film according to claim 1, wherein the polymeric substrate comprises a free shrink of in the range of from 1% to 6% at 95° C. according to ASTM D2732.

16. The barrier packaging film according to claim 1, wherein the polymeric buffer layer comprises vinyl alcohol copolymer, polypropylene-based polymer, polyurethane-based polymer or polylactic acid.

17. (canceled)

18. A barrier packaging film comprising:
a polyolefin substrate,
an inorganic coating layer,
a polymeric buffer layer positioned between the polyolefin substrate and the inorganic coating layer, the polymeric buffer layer in direct contact with the inorganic coating layer, and
a polyolefin sealing layer,
wherein
the inorganic coating layer comprises a wave structure characterized by an average amplitude in the range of from 0.25 μm to 1.0 μm and a wavelength in the range of from 2 μm to 5 μm, and
the polymeric buffer layer comprises a thickness in the range of from 1.1 to 20 times the average amplitude of said wave structure.

19. The barrier packaging film according to claim 18 further comprising an adhesive layer, wherein:
the polyolefin substrate is a first exterior layer,
the polyolefin sealing layer is a second exterior layer, and
the adhesive layer is located between the polyolefin sealing layer and the inorganic coating layer.

20. (canceled)

21. The barrier packaging film according to claim 18 further comprising a printed indicia layer and an adhesive layer, wherein:
the printed indicia layer is a first exterior layer,
the polyolefin sealing layer is a second exterior layer, and
the adhesive layer is located between the polyolefin sealing layer and the inorganic coating layer.

22. The barrier packaging film according to claim 18, wherein the polyolefin substrate is an oriented polypropylene film and the polyolefin sealing layer is a polypropylene sealing layer.

23. The barrier packaging film according to claim 22, wherein the oriented polypropylene film comprises a homopolymer polypropylene.

24. (canceled)

25. The barrier packaging film according to claim 18 further comprising an oriented polyolefin exterior layer and an adhesive layer, wherein:
the polyolefin sealing layer is a sublayer of the polyolefin substrate, and
the adhesive layer is located between the polyolefin exterior layer and the inorganic coating layer.

26. (canceled)

27. The barrier packaging film according to claim 18, wherein the barrier packaging film has a total composition including greater than or equal to 80% polyolefin, by weight.

28. (canceled)

29. (canceled)

30. (canceled)

31. (canceled)

32. (canceled)

33. (canceled)

34. (canceled)

35. (canceled)
